(19) United States
(12) Patent Application Publication
(10) Pub. No.: US 2019/0122043 A1
(43) Pub. Date: Apr. 25, 2019

(54) ELECTRONIC DOCUMENT PROCESSING

(71) Applicant: Education & Career Compass, Vienna, VA (US)

(72) Inventors: Sunil BALA, McLean, VA (US); Kristopher Philip BARTH, McLean, VA (US); Rahul BHATNAGAR, Sterling, VA (US)

(73) Assignee: Education & Career Compass, Vienna, VA (US)

(21) Appl. No.: 15/792,202

(22) Filed: Oct. 24, 2017

Related U.S. Application Data
(63) Continuation of application No. 15/790,219, filed on Oct. 23, 2017, now abandoned.

(51) Int. Cl. G06K 9/00; G06F 17/21

(52) U.S. Cl. CPC G06K 9/00469; G06F 17/21; G06K 9/00463

(57) ABSTRACT

Techniques for extracting data from electronic documents, including determining vertical positions for text elements encoded in an electronic document based on an intended visual appearance of the text elements; generating text rows for subsets of the text elements based on the vertical positions of the text elements; generating text cells, each associated with one of the text rows and including characters from one or more of the text elements used for the associated text row; obtaining a first set of rules selecting a row group type as a function of an indicated text row; obtaining a second set of rules selecting a row subgroup type as a function of an indicated text row; and creating a record in an electronic database, the record including a field value based on characters included in text cell associated with a text row selected based on the first and second sets of rules.

### REFERENCE TO A RELATED APPLICATION

This application claims the benefit of priority from and is a continuation of pending U.S. patent application Ser. No. 15/790,219, filed on Oct. 23, 2017, and entitled “Electronic Document Processing,” which is incorporated by reference herein in its entirety.

### BACKGROUND

Obtaining, exchanging, and receiving data directly from the creator and/or maintainer of desired data imposes a number of obstacles. Typically, implementing such data interchange requires the design and implementation of well-defined software interfaces. Implementing such interfaces to provide data to additional parties may not be a business priority or the creator and/or maintainer may not have the necessary resources. Additionally, where multiple parties are involved, whether as sources of data or as recipients of the data, coordinating efforts among those parties can be a significant challenge.

One approach is to find other already existing vehicles for obtaining or receiving the data of interest. For example, the desired data may be released or otherwise available in the form of electronic documents in a form intended for human review. For example, a user may be able to, such as via a web service, download an electronic document, such as a PDF-formatted document. Such documents are other in “richly annotated” document formats designed mainly for printing or display, and do not offer the data in a convenient or simple form for machine-based data extraction.

Conventional solutions for extracting formatted text data from such electronic documents typically involve bespoke, custom-made software. Such solutions have a number of problems. First, development effort is significant, both for understanding how information of interest is presented in the documents and for implementing software that obtains the information according to that presentation. Second, such software is often not robust. The electronic documents are often being provided to users for other purposes than data extraction, and changes in how information is presented in the documents can change at essentially any time. Such changes may have little effect on a document's appearance to an average user, but involve a rearrangement of data or other changes to the presentation of the data that the custom-made software is not designed to accommodate. The end result often is that a document processing pipeline that has worked for some time simply stops working one day, resulting in downtime until the cause (a change in presentation of information) is understood and changes made to the software. This can result in significant burdens in terms of downstream effects on the breakdown of the document processing pipeline, maintaining and/or obtaining technical resources for effecting updates.

There is a need for techniques for extracting data from electronic documents that is both more efficient to develop and more robust against such changes to the presentation of information in the documents.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIGS. 1A-1E illustrate an intended visual appearance for an example electronic document suitable for processing by the various techniques described herein, with FIG. 1A illustrating a first page, FIG. 1B illustrating a second page, FIG. 1C illustrating a third page, FIG. 1D illustrating a fourth page, and FIG. 1E illustrating a fifth page.

FIGS. 2A and 2B illustrate an example illustrating text elements encoded in the electronic document for the first page shown in FIG. 1A. FIG. 2A shows text elements positioned within a top portion of the first page, and FIG. 2B shows text elements positioned within a bottom portion of the first page.

FIG. 3 illustrates an example of a process for using text elements identified from an electronic document, such as the text elements in FIGS. 2A and 2B, to generate associated text rows and text columns with characters and positions based on the characters and positions of the identified text elements.

FIGS. 4A-4G illustrate an example in which, much as described in connection with FIG. 3, text rows and text columns are generated based on associated text elements shown in FIGS. 2B and 4A.

FIGS. 5A-5J illustrate another example in which, much as described in connection with FIG. 3, text rows and text columns are generated based on associated text elements shown in FIGS. 2B and 5A, including concatenation of characters from multiple text elements into a single text column.

FIG. 6 illustrates an example of a process for consolidating text rows and text columns generated from an electronic document, such as text rows generated according to the process described in connection with FIG. 3.

FIGS. 7A-7E illustrate an example in which, much as described in connection with FIG. 6, row consolidation is performed for multiple initial text rows, resulting in consolidation of characters from two text rows into a different preceding text row.

FIGS. 8A-8C illustrate another example in which, much as described in connection with FIG. 6, row consolidation is performed for two initial text rows, resulting in consolidation of one text row into the other text row.

FIGS. 9A and 9B illustrate an example illustrating consolidated text rows for the first page illustrated in FIG. 1A, which were generated based on the text elements identified for the first page and shown in FIGS. 2A and 2B and Table 2. FIG. 9C illustrates a similar example of consolidated rows for a bottom portion of the second page shown in FIG. 1B. FIG. 9D illustrates a similar example of consolidated rows for a bottom middle portion of the fifth page shown in FIG. 1E.

FIG. 10 illustrates an example of a system configured to employ various techniques described above in connection with FIGS. 1-9D for, among other things, automatically identifying text item structures in visual arrangements of electronic documents, extracting selected text items from the identified structures, and creating and storing structured records containing data corresponding to the selected and extracted text items.

FIG. 11A illustrates an example of a first user interface displayed to an end user by the user frontend system via the user system shown in FIG. 10.

FIG. 11B illustrates an example of a second user interface 1130 displayed to an end user by the user frontend system 1015 via the user system 810 shown in FIG. 10.

FIG. 11C illustrates a first portion of an example of a third user interface 1160 displayed to an end user by the user frontend system 1015 via the user system 810 shown in FIG. 10. FIG. 11D illustrates a second portion of the example of the third user interface 1160 illustrated in FIG. 11C.

FIG. 12 is a block diagram illustrating an example software architecture, various portions of which may be used in conjunction with various hardware architectures herein described, which may implement any of the above-described features.

FIG. 13 is a block diagram illustrating components of an example machine configured to read instructions from a machine-readable medium (for example, a machine-readable storage medium) and perform any of the features described herein.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

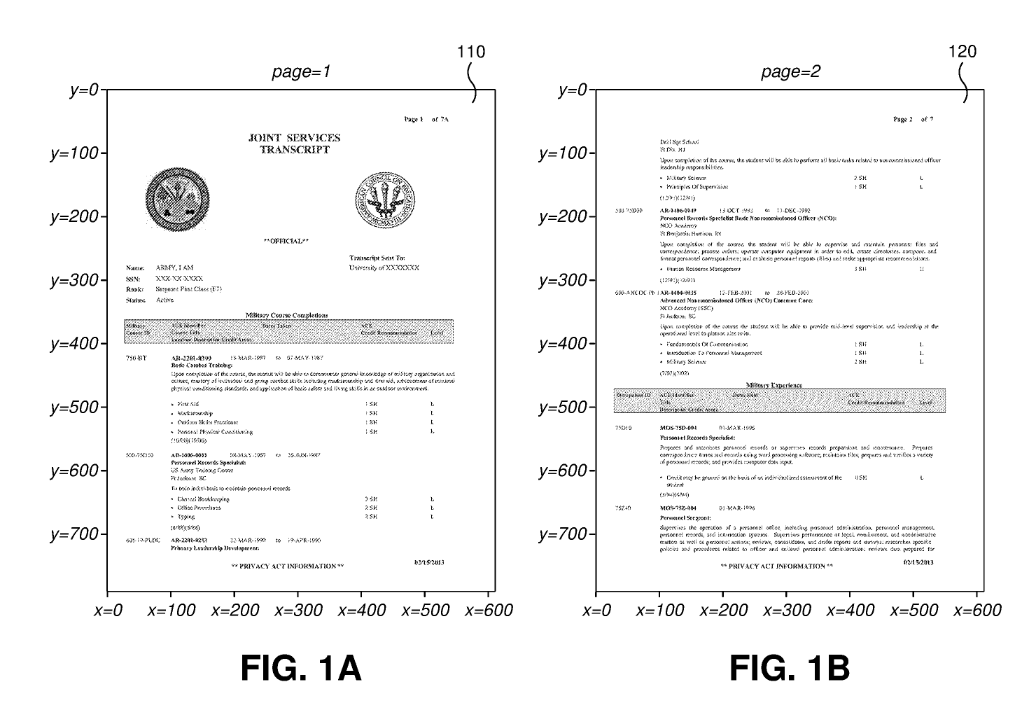

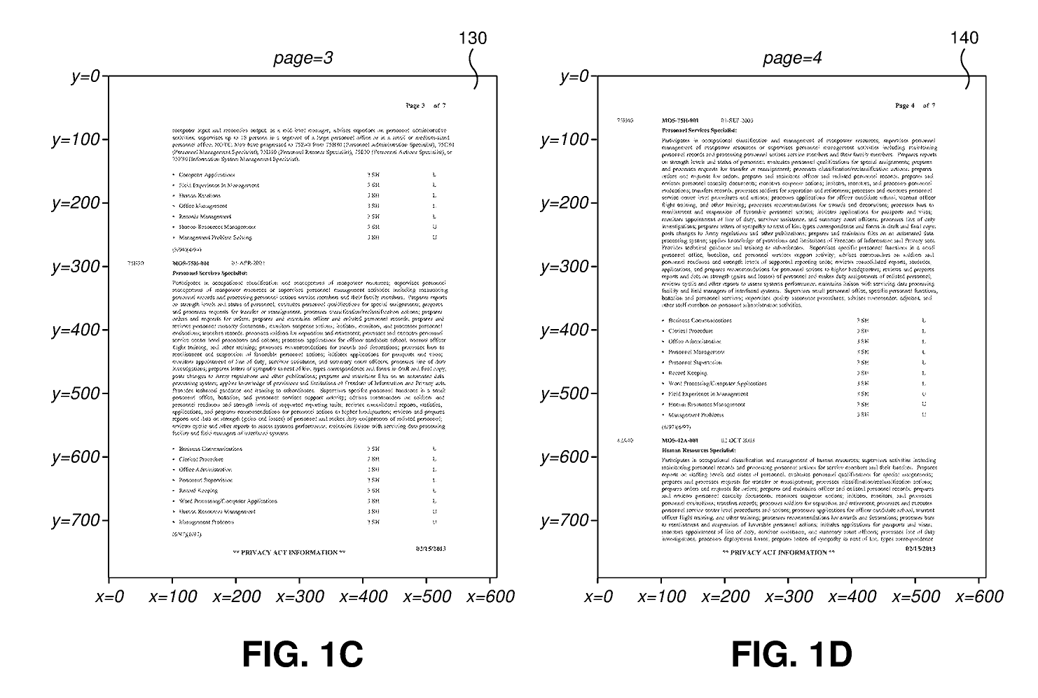

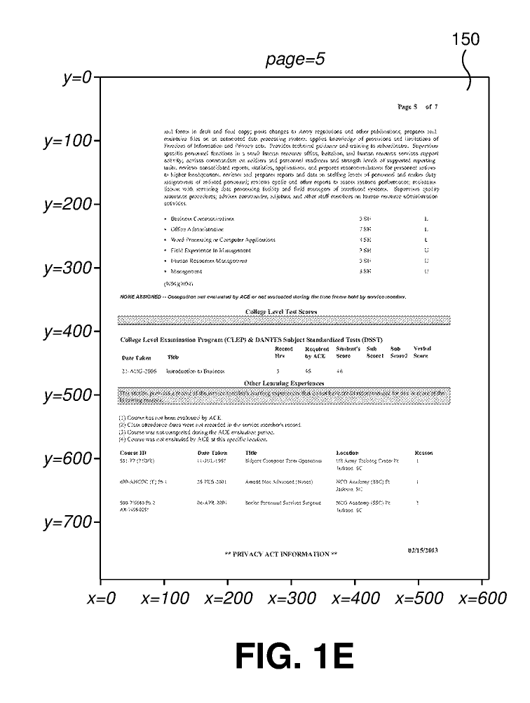

FIGS. 1A-1E illustrate an intended visual appearance for an example electronic document 100 suitable for processing by the various techniques described herein. In this particular example, the electronic document 100 is a multi-page electronic document, in which text elements and other elements are arranged across multiple pages. For purposes of this discussion, the term “text element” refers to one or more characters (which may be referred to as “glyphs”) encoded in an electronic document as a unit for display (for example, a string) and a position for the one of more characters (for example, a tuple describing a position of a beginning of a baseline for the characters on a page or in a document as a whole). The position may specify, for example, a single point, a line, or a rectangular region for the characters. Examples of a position for a text element include, but are not limited to, a beginning of, or other position along (for example, a middle position), a baseline for the characters of the text element; a corner, or other position along an edge (for example, a middle position), of a bounding box for the characters; a position along a top of the characters (for example, having a vertical position based on a baseline position and an ascent or other height); a baseline of the characters; a rectangle (which may be specified as, for example, a corner position, height, and width, or minimum and maximum x and y values) for a bounding box of the characters or other rectangle (for example, bounded by a baseline at a bottom and having a height based on an ascent or other height); and a center position for such rectangles.

In some examples, each text element may have additional metadata such as, but not limited to, a font (which may be referred to as a typeface), a font family (which may encompass multiple fonts of a similar type, and may be used as an alternative to a font), a font size, a font weight (for example, bold and/or italic), line spacing, character spacing, word spacing, color, orientation, total width, and/or height (for example, from a baseline). FIG. 1A shows a first page 110, FIG. 1B shows a second page 120, FIG. 1C shows a third page 130, FIG. 1D shows a fourth page 140, and FIG. 1E shows a fifth page 150. The example document 100 is a Joint Services Transcript document describing an individual's credentials as a result of United States military service. However, it is understood that the techniques described herein are not limited to such credentials, or to documents describing credentials.

Each of FIGS. 1A-1E further shows “y” values (ranging from 0 to 792 in this example) for a vertical position component, and “x” values (ranging from 0 to 612 in this example) for a horizontal position component. Later examples will reference the illustrated arrangement of x and y values to express two-dimensional positions, at least in part, within the document 100. In some implementations in which a multi-page electronic document, such as the document 100 illustrated in FIGS. 1A-1E, is being processed, positions within the document may be expressed as a triple or triplet including a page number, a horizontal or “x” position, and a vertical or “y” position. The units for the illustrated position component values is arbitrary. In this example, there are 72 units per inch (approximately 28.35 units per centimeter), and the units correspond to units used in the document 100 and/or a standard or other definition of the document format to express positions and dimensions of elements. Different units may be used for x position components and y position components. For example, it may be desired to use an absolute unit (such as inches, points, or centimeters) for the horizontal component, and a percentage of page width for the vertical component. Additionally, although the illustrated example shows an origin for the coordinate system at the top left corner of the document (which may be convenient for documents with left-to-right, top-to-bottom script), other positions for the origin may be used. Although in this example each of the pages 110, 120, 130, 140, and 150 of the electronic document 100 is arranged in a “portrait” orientation (oriented to have a greater height than width) and has the same dimensions as the other pages, in other examples a single document may include pages arranged with different orientations (some pages portrait, and others landscape) and/or pages with different sizes.

For the sake of illustration, the electronic document 100 is a PDF file that encodes data, including text, according to the PDF document format. However, it is understood that the techniques described herein are not limited to PDF documents. Table 1, below, presents an example portion of the PDF file for the first page 100, including, among other things, operators identifying all of the text elements intended for display for the first page 110. Line numbers have been added in brackets for later reference to specific portions of Table 1.

TABLE 1
Example PDF Encoding for Text Elements of First Page 110

| | |
|---|---|
| [1] | BT |
| [2] | /CS0 cs 1 scn |
| [3] | /GS0 gs |
| [4] | /C2_0 1 Tf |
| [5] | 10.3889 0 0 10.3889 469.6169 743.4044 Tm |
| [6] | [<00330044004A0048>−2174<00520049>]TJ |
| [7] | 2.4 −0.036 Td |
| [8] | <0014>Tj |
| [9] | −0.836 −67.495 Td |
| [10] | <0013001500120014001800120015001300140016>Tj |
| [11] | −0.0001 Tc 0.0001 Tw −27.909 −0.542 Td |
| [12] | <000D000D000300330035002C003900240026003C00030024002600370003002C |
| | 0031002900320035003000240037002C003200310003000D000D>Tj |
| [13] | 0 Tc 0 Tw 31.869 68.036 Td |
| [14] | <001A>Tj |
| [15] | /C2_1 1 Tf |
| [16] | 0.5 0.001 Td |
| [17] | <0024>Tj |
| [18] | /C2_2 1 Tf |
| [19] | −43.871 −22.585 Td |
| [20] | <0024>Tj |
| [21] | /TT0 1 Tf |
| [22] | (R)Tj |
| [23] | /C2_2 1 Tf |
| [24] | <0030003C>Tj |
| [25] | /TT0 1 Tf |
| [26] | (, )Tj |
| [27] | /C2_2 1 Tf |
| [28] | <002C000300240030>Tj |
| [29] | /TT0 1 Tf |
| [30] | ( )Tj |
| [31] | −0.0002 Tc 0 −1.637 TD |
| [32] | (XXX-XX-XXXX)Tj |
| [33] | 0 Tc 0 −1.607 TD |
| [34] | (Sergeant First Class \(E7\))Tj |
| [35] | /C2_2 1 Tf |
| [36] | 29.494 3.266 Td |
| [37] | <00380051004C0059004800550056004C0057005C0003005200490003003B003B |
| | 003B003B003B003B003B>Tj |
| [38] | /TT0 1 Tf |
| [39] | ( )Tj |
| [40] | /C2_0 1 Tf |
| [41] | 0 1.487 TD |
| [42] | <0037005500440051005600460055004C00530057000300360048005100570003 |
| | 00370052001D>Tj |
| [43] | −34.022 −1.556 Td |
| [44] | <0031004400500048001D>Tj |
| [45] | −0.0002 Tc 0 −1.705 TD |
| [46] | <003600360031001D>Tj |
| [47] | 0 −1.567 TD |
| [48] | <003500440051004E001D>Tj |
| [49] | −0.0001 Tc 0.0001 Tw 17 0 0 17 222.9644 711.7843 Tm |
| [50] | <002D0032002C00310037000300030036002800350039002C002600280036>Tj |
| [51] | 0 Tw 1.042 −1.124 Td |
| [52] | <0037003500240031003600260035002C00330037>Tj |
| [53] | 0 Tc 10.3889 0 0 10.3889 246.8785 550.3975 Tm |
| [54] | <000D000D003200290029002C0026002C0024002F000D000D>Tj |
| [55] | −2.716 −11.295 Td |
| [56] | <0030004C004F004C005700440055005C00030026005200580055005600480003 |
| | 0026005200500053004F00480057004C005200510056>Tj |
| [57] | ET |
| [58] | q |
| [59] | 388.017 568.531 102 102 re |
| [60] | W n |
| [61] | q |
| [62] | 102.129 0 0 102.072 387.954 568.464 cm |
| [63] | /Im0 Do |
| [64] | Q |
| [65] | Q |
| [66] | BT |
| [67] | /TT0 1 Tf |
| [68] | 0.0001 Tc 10.3889 0 0 10.3889 76.8023 457.6524 Tm |
| [69] | (Active)Tj |
| [70] | /C2_0 1 Tf |
| [71] | −0.0001 Tc −4.564 −0.044 Td |
| [72] | <003600570044005700580056001D>Tj |
| [73] | ET |
| [74] | 0.16 scn |
| [75] | 27.011 392.448 519.937 36.833 re |
| [76] | f |
| [77] | /CS0 CS 1 SCN |
| [78] | 0.944 w |
| [79] | /GS1 gs |
| [80] | 27.011 392.448 519.937 36.833 re |
| [81] | S |
| [82] | BT |
| [83] | 1 scn |
| [84] | /C2_0 1 Tf |
| [85] | 0.0001 Tc 8.5 0 0 8.5 29.3911 417.1173 Tm |
| [86] | <0030004C004F004C005700440055005C>Tj |
| [87] | −0.0001 Tc 0.0001 Tw 0 −1.333 TD |
| [88] | <0026005200580055005600480003002C0027>Tj |
| [89] | 0 Tc 0 Tw 8.396 1.418 Td |
| [90] | <0024002600280003002C0047004800510057004C0049004C00480055>Tj |
| [91] | T* |
| [92] | <00260052005800550056004800030037004C0057004F0048>Tj |
| [93] | T* |
| [94] | <002F0052004600440057004C00520051001000270048005600460055004C0053 |
| | 0057004C0052005100100026005500480047004C005700030024005500480044 |
| | 0056>Tj |
| [95] | −0.0001 Tc 0.0001 Tw 16.956 2.582 Td |
| [96] | <00270044005700480056000300370044004E00480051>Tj |
| [97] | 18.359 0 Td |
| [98] | <002400260028>Tj |
| [99] | 0 Tc 0 Tw 0.001 −1.333 Td |
| [100] | [<0026005500480047004C00570003003500480046005200500050004800510047 |
| | 00440057004C00520051>−2452<002F004800590048004F>]TJ |
| [101] | 9.4445 0 0 9.4445 100.7532 354.2922 Tm |
| [102] | <002500440056004C004600030026005200500045004400570003003700550044 |
| | 004C0051004C0051004A001D>Tj |
| [103] | /TT0 1 Tf |
| [104] | 0.0001 Tc 0.0079 Tw 0 −1.428 TD |
| [105] | (Upon completion of the course, the recruit will be able to |
| | demonstrate g\ |
| [106] | eneral knowledge of military organization and)Tj |
| [107] | 0.0359 Tw 0 −1.2 TD |
| [108] | (culture, mastery of individual and group combat skills including |
| | marksma\ |
| [109] | nship and first aid, achievement of minimal )Tj |
| [110] | −0.0001 Tw T* |
| [111] | (physical conditioning standards, and application of basic safety and |
| | liv\ |
| [112] | ing skills in an outdoor environment.)Tj |
| [113] | /c2_0 1 Tf |
| [114] | 0 Tc 0 Tw 10.3889 0 0 10.3889 100.7532 364.9082 Tm |
| [115] | <0024003500100015001500130014001000130016001C001C>Tj |
| [116] | /TT0 1 Tf |
| [117] | −6.869 0.069 Td |
| [118] | (750-BT)Tj |
| [119] | 9.4445 0 0 9.4445 194.0644 366.3062 Tm |
| [120] | [(13-MAR-1987)-3584(07-MAY-1987)]TJ |
| [121] | −8.84 −7.776 Td |
| [122] | (First Aid)Tj |
| [123] | 0 −1.532 TD |
| [124] | (Marksmanship)Tj |
| [125] | T* |
| [126] | (Outdoor Skills Practicum)Tj |
| [127] | T* |
| [128] | (Personal Physical Conditioning)Tj |
| [129] | 42.424 4.668 Td |
| [130] | (L)Tj |
| [131] | T* |
| [132] | (L)Tj |
| [133] | T* |
| [134] | (L)Tj |
| [135] | T* |
| [136] | (L)Tj |
| [137] | −0.0001 Tc 0.0001 Tw −10.952 4.524 Td |
| [138] | (1 SH)Tj |
| [139] | T* |
| [140] | (1 SH)Tj |
| [141] | T* |
| [142] | (1 SH)Tj |
| [143] | T* |
| [144] | (1 SH)Tj |
| [145] | /C2_0 1 Tf |
| [146] | 0 Tc 0 Tw −32.588 −5.208 Td |
| [147] | <00330048005500560052005100510048004F0003003500480046005200550047 |
| | 005600030036005300480046004C0044004F004C00560057001D>Tj |
| [148] | 0 −14.276 TD |
| [149] | <00330055004C005000440055005C0003002F004800440047004800550056004B |
| | 004C005300030027004800590048004F005200530050004800510057001D>Tj |
| [150] | 0 15.552 TD |
| [151] | <002400350010001400170013001900100013001300140014>Tj |
| [152] | 0 −14.276 TD |
| [153] | <002400350010001500150013001400100013001500180016>Tj |
| [154] | /TT0 1 Tf |
| [155] | 9.956 14.276 Td |
| [156] | (08-MAY-1987)Tj |
| [157] | T* |
| [158] | (22-MAR-1990)Tj |
| [159] | −0.0001 Tc 9.604 14.276 Td |
| [160] | (26-JUN-1987)Tj |
| [161] | 0 Tc T* |
| [162] | (19-APR-1990)Tj |
| [163] | 0.0001 Tc −0.0001 Tw −19.56 8.66 Td |
| [164] | (To train individuals to maintain personnel records.)Tj |
| [165] | 0 Tc 0 Tw −7.48 5.616 Td |
| [166] | (500-75D10)Tj |
| [167] | T* |
| [168] | (605-19-PLDC)Tj |
| [169] | 7.48 11.728 Td |
| [170] | (US Army Training Center)Tj |
| [171] | 0 −1.344 TD |
| [172] | (Ft Jackson SC)Tj |
| [173] | 0.0001 Tc −0.0001 Tw 1.116 −3.436 Td |
| [174] | (Clerical Bookkeeping)Tj |
| [175] | 0 Tc 0 Tw 0 −1.476 TD |
| [176] | (Office Procedures)Tj |
| [177] | 0.0001 Tc 0 −1.48 TD |
| [178] | (Typing)Tj |
| [179] | −0.0001 Tc 0.0001 Tw 31.472 2.956 Td |
| [180] | (3 SH)Tj |
| [181] | 0 −1.476 TD |
| [182] | (2 SH)Tj |
| [183] | 0 −1.48 TD |
| [184] | (2 SH)Tj |
| [185] | 0 Tc 0 Tw 10.952 2.956 Td |
| [186] | (L)Tj |
| [187] | 0 −1.476 TD |
| [188] | (L)Tj |
| [189] | 0 −1.48 TD |
| [190] | (L)Tj |
| [191] | −43.472 12.704 Td |
| [192] | (\(10/00\)\(10/00\))Tj |
| [193] | −0.068 −14.596 Td |
| [194] | (\(8/88\)\(8/88\))Tj |
| [195] | ET |
| [196] | q |
| [197] | 1 0 0 1 103.473 294.868 cm |
| [198] | 0 0 m |
| [199] | 0 0.755 −0.566 1.322 −1.36 1.322 c |
| [200] | −2.153 1.36 −2.72 0.755 −2.72 0 c |
| [201] | −2.72 −0.756 −2.153 −1.322 −1.36 −1.322 c |
| [202] | −0.566 −1.36 0 −0.756 0 0 c |
| [203] | f* |
| [204] | Q |
| [205] | q |
| [206] | 1 0 0 1 103.473 280.399 cm |
| [207] | 0 0 m |
| [208] | 0 0.756 −0.566 1.322 −1.36 1.322 c |
| [209] | −2.153 1.36 −2.72 0.756 −2.72 0 c |
| [210] | −2.72 −0.756 −2.153 −1.322 −1.36 −1.322 c |
| [211] | −0.566 −1.36 0 −0.756 0 0 c |
| [212] | f* |
| [213] | Q |
| [214] | q |
| [215] | 1 0 0 1 103.473 265.93 cm |
| [216] | 0 0 m |
| [217] | 0 0.756 −0.566 1.322 −1.36 1.322 c |
| [218] | −2.153 1.36 −2.72 0.756 −2.72 0 c |
| [219] | −2.72 −0.755 −2.153 −1.322 −1.36 −1.322 c |
| [220] | −0.566 −1.36 0 −0.755 0 0 c |
| [221] | f* |
| [222] | Q |
| [223] | q |
| [224] | 1 0 0 1 103.473 251.461 cm |
| [225] | 0 0 m |
| [226] | 0 0.756 −0.566 1.322 −1.36 1.322 c |
| [227] | −2.153 1.36 −2.72 0.756 −2.72 0 c |
| [228] | −2.72 −0.755 −2.153 −1.322 −1.36 −1.322 c |
| [229] | −0.566 −1.36 0 −0.755 0 0 c |
| [230] | f* |
| [231] | Q |
| [232] | q |
| [233] | 1 0 0 1 103.473 145.797 cm |
| [234] | 0 0 m |
| [235] | 0 0.755 −0.566 1.313 −1.36 1.313 c |
| [236] | −2.153 1.36 −2.72 0.755 −2.72 0 c |
| [237] | −2.72 −0.756 −2.153 −1.322 −1.36 −1.322 c |
| [238] | −0.566 −1.36 0 −0.756 0 0 c |
| [239] | f* |
| [240] | Q |
| [241] | q |
| [242] | 1 0 0 1 103.473 131.819 cm |
| [243] | 0 0 m |
| [244] | 0 0.756 −0.566 1.322 −1.36 1.322 c |
| [245] | −2.153 1.36 −2.72 0.756 −2.72 0 c |
| [246] | −2.72 −0.756 −2.153 −1.322 −1.36 −1.322 c |
| [247] | −0.566 −1.36 0 −0.756 0 0 c |
| [248] | f* |
| [249] | Q |
| [250] | q |
| [251] | 1 0 0 1 103.473 117.841 cm |
| [252] | 0 0 m |
| [253] | 0 0.756 −0.566 1.322 −1.36 1.322 c |
| [254] | −2.153 1.36 −2.72 0.756 −2.72 0 c |
| [255] | −2.72 −0.755 −2.153 −1.322 −1.36 −1.322 c |
| [256] | −0.566 −1.36 0 −0.755 0 0 c |
| [257] | f* |
| [258] | Q |
| [259] | BT |
| [260] | /TT0 1 Tf |
| [261] | 0.0002 Tc 9.4445 0 0 9.4445 266.3715 366.7592 Tm |
| [262] | (to)Tj |
| [263] | 0 −16.32 TD |
| [264] | (to)Tj |
| [265] | 0 −14.276 TD |
| [266] | (to)Tj |
| [267] | ET |

PDF documents are encoded according to a presentation-oriented format (for example, for presentation via a display or printer device) that describes an intended visual appearance of a document as one or more pages, each having a fixed layout of graphical elements including text. Various portions may be encoded as PDF objects, including an object for each page providing a respective page content stream. In PDF documents, text characters for display are encoded as string operands of text-showing operators (for example, the “Tj”, single-quote character, double-quote character, and “TJ” operators) in page content streams. In a PDF document, different character encodings may apply for a string operand according to a selected font resource. For example, in line 44 of Table 1, the string “Name:” is encoded according to a character mapping for a font subset selected at line 40, whereas in line 32 of Table 1, the string “XXX-XX-XXXX” is encoded as simple ASCII text according to the font selected at line 29.

In this example, each string operand of a PDF text-showing operator is treated as identifying an occurrence of a separate text element having the characters encoded in the PDF document for the string operand. Thus, a single PDF text-showing operator may, in some cases, identify multiple text elements. For example, line 120 in Table 1 is for a single PDF text-showing operator with two string operators, and accordingly two text elements (a first text element having the characters “13-MAR-1987” and a second text element having the characters “7-MAY-1987”). It is noted that a position for a text element identified from a string operand of a PDF text-showing operator, as well as additional metadata (for example, a font, a font family, a font size, a font weight, line spacing, character spacing, orientation, total width, and/or height) is not expressly included in the PDF text-showing operator, but instead is determined based on at least a text state and/or graphics state that applies to displaying the string operand (based at least on effects of previous stream operations), and/or font data for the current font indicated by the text state (including, for example, character width information). Although other approaches may be used to identify text elements in PDF documents, the use of string operands of PDF text-showing operators described above accommodates situations where another PDF text-showing operator identifies a text element positioned laterally between other text elements (such as line 262 in Table 1, encoding the word “to” between the two text elements from line 120).

Objects, including page content streams and other objects involved in determining a visual appearance of a page, can be arranged in essentially any order within a PDF file. Further, as illustrated in the example in Table 1, text-showing operators are usually not arranged according to a top-to-bottom order (or human reading order). In some cases, a line or text, or even a word, is divided into multiple text elements. Thus, whether or not page content streams have been arranged in a PDF file in page order (for example, a “linear” or “web optimized” PDF file), text elements not only can be, but usually are, encoded in a PDF file in an order that does not correspond to the vertical positions, or even necessarily the horizontal positions, of the text elements within a page and/or the document as a whole. In addition to text elements, a page content stream includes various operators that can affect the graphics state (for example, coordinate transformations) and in turn affect where and/or how text elements get rendered.

Due to such issues, of which only a small fraction has been described, extraction of text information from a PDF document with any significant amount or arrangement of text requires more than a simple top-to-bottom parsing of the file to identify text elements and their contents (as might be done for “well structured” document formats, such as XML). Instead, a large number and variety of PDF operators and objects that might seem to have little relevance to extracting text information must nevertheless be interpreted and processed to update an ongoing graphics state to determine how the text-showing operators for the text elements for text information of interest are intended to be visually rendered. It is noted that such issues and considerations are not limited to PDF documents.

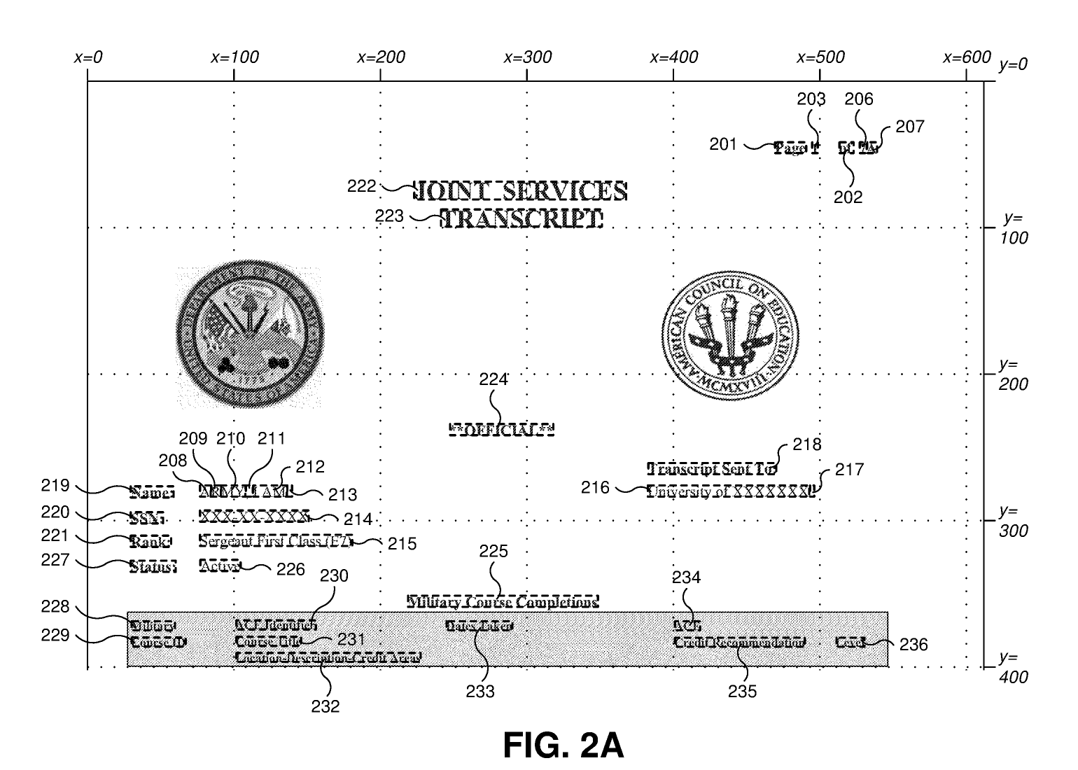

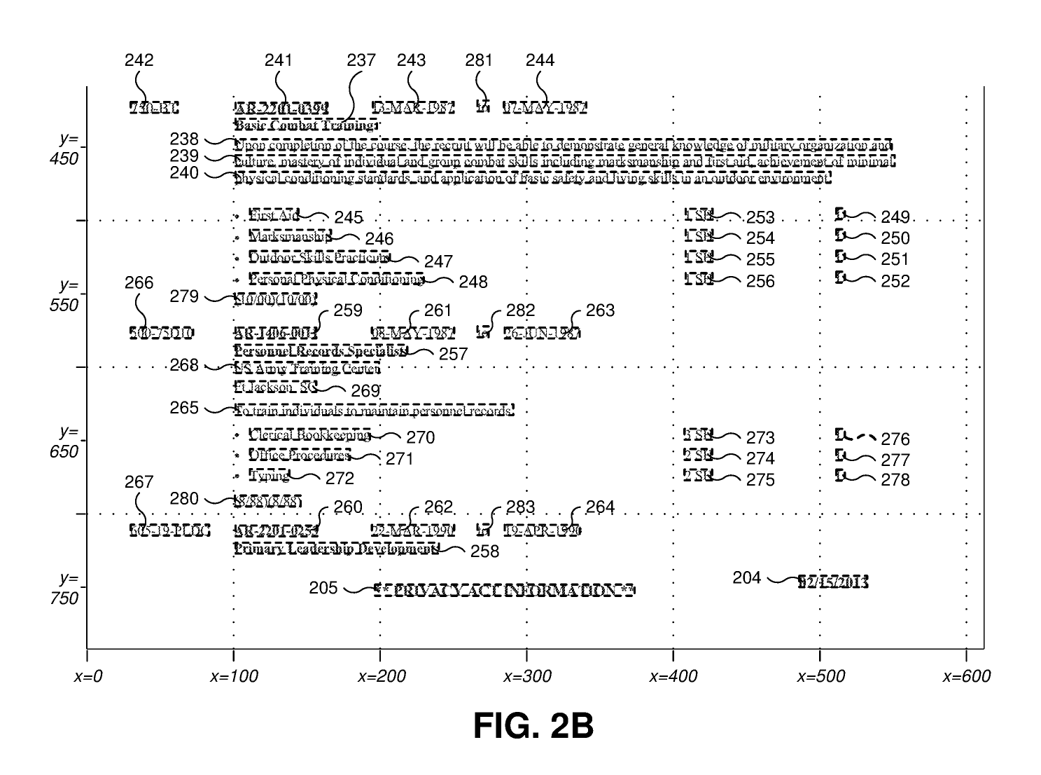

FIGS. 2A and 2B illustrate an example illustrating text elements 201-283 encoded in the electronic document 100 for the first page 110 shown in FIG. 1A. FIG. 2A shows text elements positioned within a top portion of the first page 110 (with a y value less than 400, in this example), and FIG. 2B shows text elements positioned within a bottom portion of the first page 110 (with a y value greater than 400 in this example). The numeric order of the reference numerals for the text elements 201-283 is the same as the order in which a corresponding string operator of a PDF text-showing operator appears in Table 1, above. Table 2, below, provides details about the intended visual appearance for each of the text elements 201-283 and the corresponding line or lines in Table 1 (“line”) for each text element. The details provided for each text element include: x and y coordinates specifying a position of the text element (in this example, corresponding to a baseline for the text element), a total width “w” of the text element, a height “h” (in this example, an ascent above the baseline for the applicable graphics state), a font weight (for example, bold and/or italic), a font size (which may be specified in a different unit than used for the position coordinates), a typeface, and a “value” indicating the one or more characters of the text element within double quotes. In some implementations, the “x”, “y”, “w”, and “h” values may be replaced with “min_x”, “max_x”, “min_y”, and “max_y” values for specifying vertical and horizontal extents for identified text elements.

TABLE 2
Text Elements Identified for First Page 110

| | |
|---|---|
| [201] | line:6 x:469.62 y:48.60 w:21.35 h:9.11 weight:bold fontsize:10 |
| | face:VCFALI+TimesNewRoman value:”Page” |
| [202] | line:6 x:513.55 y:48.60 w:8.65 h:9.11 weight:bold fontsize:10 |
| | face:VCFALI+TimesNewRoman value:”of” |
| [203] | line:8 x:494.55 y:48.97 w:5.19 h:9.11 weight:bold fontsize:10 |
| | face:VCFALI+TimesNewRoman value:”1” |
| [204] | line:10 x:485.87 y:750.17 w:47.33 h:9.11 weight:bold fontsize:10 |
| | face:VCFALI+TimesNewRoman value:”02/15/2013” |
| [205] | line:12 x:195.92 y:755.80 w:178.29 h:9.11 weight:bold fontsize:10 |
| | face:VCFALI+TimesNewRoman value:”** PRIVACY ACT INFORMATION **” |
| [206] | line:14 x:527.01 y:48.97 w:7.71 h:9.11 weight:bold fontsize:10 |
| | face:VCFALI+TimesNewRoman value:”7” |
| [207] | line:17 x:532.20 y:48.97 w:7.29 h:9.11 weight:bold fontsize:10 |
| | face:TimesNewRoman value:”A” |
| [208] | line:20 x:76.43 y:283.60 w:7.18 h:8.97 weight:none fontsize:10 |
| | face:TimesNewRoman value:”A” |
| [209] | line:22 x:83.93 y:283.60 w:6.63 h:8.97 weight:none fontsize:10 |
| | face:TimesNewRomanPSMT value:”R” |
| [210] | line:24 x:91.10 y:283.60 w:16.06 h:8.97 weight:none fontsize:10 |
| | face:TimesNewRoman value:”MY” |
| [211] | line:26 x:108.20 y:283.60 w:5.01 h:8.97 weight:none fontsize:10 |
| | face:TimesNewRomanPSMT value:”, ” |
| [212] | line:28 x:113.10 y:283.60 w:21.80 h:8.97 weight:none fontsize:10 |
| | face:TimesNewRoman value:”I AM” |
| [213] | line:30 x:135.60 y:283.60 w:2.49 h:8.97 weight:none fontsize:10 |
| | face:TimesNewRomanPSMT value:” ” |
| [214] | line:32 x:76.43 y:300.61 w:74.41 h:8.97 weight:none fontsize:10 |
| | face:TimesNewRomanPSMT value:”XXX-XX-XXXX” |
| [215] | line:34 x:76.43 y:317.31 w:104.17 h:8.97 weight:none fontsize:10 |
| | face:TimesNewRomanPSMT value:”Sergeant First Class (E7)” |
| [216] | line:37 x:382.84 y:283.37 w:101.02 h:8.97 weight:none fontsize:10 |
| | face:TimesNewRomanPSMT value:”University of XXXXXXX” |
| [217] | line:39 x:484.26 y:283.37 w:2.49 h:8.97 weight:none fontsize:10 |
| | face:TimesNewRomanPSMT value:” ” |
| [218] | line:42 x:382.84 y:267.93 w:88.31 h:9.11 weight:bold fontsize:10 |
| | face:VCFALI+TimesNewRoman value:”Transcript Sent To:” |
| [219] | line:44 x:29.39 y:284.09 w:29.42 h:9.11 weight:bold fontsize:10 |
| | face:VCFALI+TimesNewRoman value:”Name:” |
| [220] | line:46 x:29.39 y:301.80 w:22.51 h:9.11 weight:bold fontsize:10 |
| | face:VCFALI+TimesNewRoman value:”SSN:” |
| [221] | line:48 x:29.39 y:318.07 w:27.70 h:9.11 weight:bold fontsize:10 |
| | face:VCFALI+TimesNewRoman value:”Rank:” |
| [222] | line:50 x:222.96 y:80.22 w:145.45 h:15.28 weight:bold fontsize:17 |
| | face:VCFALI+TimesNewRoman value:”JOINT SERVICES” |
| [223] | line:52 x:240.68 y:99.32 w:110.48 h:15.28 weight:bold fontsize:17 |
| | face:VCFALI+TimesNewRoman value:”TRANSCRIPT” |
| [224] | line:54 x:246.88 y:241.60 w:71.57 h:9.11 weight:bold fontsize:10 |
| | face:VCFALI+TimesNewRoman value:”**OFFICIAL**” |
| [225] | line:56 x:218.66 y:358.95 w:129.85 h:9.11 weight:bold fontsize:10 |
| | face:VCFALI+TimesNewRoman value:”Military Course Completions” |
| [226] | line:69 x:76.80 y:334.35 w:27.70 h:8.97 weight:none fontsize:10 |
| | face:TimesNewRomanPSMT value:”Active” |
| [227] | line:72 x:29.39 y:334.80 w:31.16 h:9.11 weight:bold fontsize:10 |
| | face: VCFALI+TimesNewRoman value:”Status:” |
| [228] | line:86 x:29.39 y:374.88 w:30.22 h:7.21 weight:bold fontsize:8 |
| | face:VCFALI+TimesNewRoman value:”Military” |
| [229] | line:88 x:29.39 y:386.21 w:37.52 h:7.21 weight:bold fontsize:8 |
| | face:VCFALI+TimesNewRoman value:”Course ID” |
| [230] | line:90 x:100.76 y:374.16 w:54.54 h:7.21 weight:bold fontsize:8 |
| | face:VCFALI+TimesNewRoman value:”ACE Identifier” |
| [231] | line:92 x:100.76 y:385.49 w:45.09 h:7.21 weight:bold fontsize:8 |
| | face:VCFALI+TimesNewRoman value:”Course Title” |
| [232] | line:94 x:100.76 y:396.82 w:126.77 h:7.21 weight:bold fontsize:8 |
| | face:VCFALI+TimesNewRoman value:”Location-Description-Credit Areas” |
| [233] | line:96 x:244.88 y:374.87 w:45.56 h:7.21 weight:bold fontsize:8 |
| | face:VCFALI+TimesNewRoman value:”Dates Taken” |
| [234] | line:98 x:400.93 y:374.87 w:17.94 h:7.21 weight:bold fontsize:8 |
| | face:VCFALI+TimesNewRoman value:”ACE” |
| [235] | line:100 x:400.94 y:386.20 w:89.47 h:7.21 weight:bold fontsize:8 |
| | face:VCFALI+TimesNewRoman value:”Credit Recommendation” |
| [236] | line:100 x:511.26 y:386.20 w:19.83 h:7.21 weight:bold fontsize:8 |
| | face:VCFALI+TimesNewRoman value:”Level” |
| [237] | line:102 x:100.75 y:437.71 w:97.60 h:8.19 weight:bold fontsize:9 |
| | face:VCFALI+TimesNewRoman value:”Basic Combat Training:” |
| [238] | line:105 x:100.75 y:451.19 w:448.34 h:8.11 weight:none fontsize:9 |
| | face:TimesNewRomanPSMT |
| | value:”Upon completion of the course, the recruit will be able to |
| | demonstrate general knowledge of military organization and” |
| [239] | line:108 x:100.75 y:462.53 w:449.31 h:8.11 weight:none fontsize:9 |
| | face:TimesNewRomanPSMT |
| | value:”culture, mastery of individual and group combat skills |
| | including marksmanship and first aid, achievement of minimal ” |
| [240] | lines:111+112 |
| | x:100.75 y:473.86 w:407.22 h:8.11 weight:none fontsize:9 |
| | face:TimesNewRomanPSMT |
| | value:”physical conditioning standards, and application of basic |
| | safety and living skills in an outdoor environment.” |
| [241] | line:115 x:100.75 y:427.09 w:63.48 h:9.11 weight:bold fontsize:10 |
| | face:VCFALI+TimesNewRoman value:”AR-2201-0399” |
| [242] | line:118 x:29.39 y:426.37 w:32.32 h:8.11 weight:none fontsize:9 |
| | face:TimesNewRomanPSMT value:”750-BT” |
| [243] | line:120 x:194.06 y:425.69 w:56.14 h:8.11 weight:none fontsize:9 |
| | face:TimesNewRomanPSMT value:”13-MAR-1987” |
| [244] | line:120 x:284.05 y:425.69 w:56.66 h:8.11 weight:none fontsize:9 |
| | face:TimesNewRomanPSMT value:”07-MAY-1987” |
| [245] | line:122 x:110.58 y:499.13 w:33.85 h:8.11 weight:none fontsize:9 |
| | face:TimesNewRomanPSMT value:”First Aid” |
| [246] | line:124 x:110.58 y:513.60 w:21.35 h:8.11 weight:none fontsize:9 |
| | face:TimesNewRomanPSMT value:”Marksmanship” |
| [247] | line:126 x:110.58 y:528.07 w:21.35 h:8.11 weight:none fontsize:9 |
| | face:TimesNewRomanPSMT value:”Outdoor Skills Practicum” |
| [248] | line:128 x:110.58 y:542.54 w:21.35 h:8.11 weight:none fontsize:9 |
| | face:TimesNewRomanPSMT value:”Personal Physical Conditioning” |
| [249] | line:130 x:511.25 y:498.45 w:5.77 h:8.11 weight:none fontsize:9 |
| | face:TimesNewRomanPSMT value:”L” |
| [250] | line:132 x:511.25 y:512.92 w:5.77 h:8.11 weight:none fontsize:9 |
| | face:TimesNewRomanPSMT value:”L” |
| [251] | line:134 x:511.25 y:527.39 w:5.77 h:8.11 weight:none fontsize:9 |
| | face:TimesNewRomanPSMT value:”L” |
| [252] | line:136 x:511.25 y:541.86 w:5.77 h:8.11 weight:none fontsize:9 |
| | face:TimesNewRomanPSMT value:”L” |
| [253] | line:138 x:407.81 y:499.13 w:19.15 h:8.11 weight:none fontsize:9 |
| | face:TimesNewRomanPSMT value:”1 SH” |
| [254] | line:140 x:407.81 y:513.60 w:19.15 h:8.11 weight:none fontsize:9 |
| | face:TimesNewRomanPSMT value:”1 SH” |
| [255] | line:142 x:407.81 y:528.07 w:19.15 h:8.11 weight:none fontsize:9 |
| | face:TimesNewRomanPSMT value:”1 SH” |
| [256] | line:144 x:407.81 y:542.54 w:19.15 h:8.11 weight:none fontsize:9 |
| | face:TimesNewRomanPSMT value:”1 SH” |
| [257] | line:147 x:100.03 y:591.73 w:119.10 h:8.19 weight:bold fontsize:9 |
| | face:VCFALI+TimesNewRoman value:”Personnel Records Specialist:” |
| [258] | line:149 x:100.03 y:726.56 w:178.30 h:8.19 weight:bold fontsize:9 |
| | face:VCFALI+TimesNewRoman value:”Primary Leadership Development:” |
| [259] | line:151 x:100.03 y:579.68 w:57.71 h:9.11 weight:bold fontsize:10 |
| | face: VCFALI+TimesNewRoman value:”AR-1406-0011” |
| [260] | line:153 x:100.03 y:714.51 w:57.71 h:9.11 weight:bold fontsize:10 |
| | face: VCFALI+TimesNewRoman value:”AR-2201-0253” |
| [261] | line:156 x:194.06 y:579.68 w:56.66 h:8.11 weight:none fontsize:9 |
| | face:TimesNewRomanPSMT value:”08-MAY-1987” |
| [262] | line:158 x:194.06 y:714.51 w:56.14 h:8.11 weight:none fontsize:9 |
| | face:TimesNewRomanPSMT value:”22-MAR-1990” |
| [263] | line:160 x:284.77 y:579.68 w:51.93 h:8.11 weight:none fontsize:9 |
| | face:TimesNewRomanPSMT value:”26-JUN-1987” |
| [264] | line:162 x:284.77 y:714.51 w:52.99 h:8.11 weight:none fontsize:9 |
| | face:TimesNewRomanPSMT value:”19-APR-1990” |
| [265] | line:164 x:100.03 y:632.72 w:191.27 h:8.11 weight:none fontsize:9 |
| | face:TimesNewRomanPSMT |
| | value:”To train individuals to maintain personnel records.” |
| [266] | line:166 x:29.39 y:579.68 w:43.02 h:8.11 weight:none fontsize:9 |
| | face:TimesNewRomanPSMT value:”500-75D10” |
| [267] | line:168 x:29.39 y:714.51 w:54.04 h:8.97 weight:none fontsize:10 |
| | face:TimesNewRomanPSMT value:”605-19-PLDC” |
| [268] | line:170 x:100.03 y:603.74 w:98.89 h:8.11 weight:none fontsize:9 |
| | face:TimesNewRomanPSMT value:”US Army Training Center” |
| [269] | line:172 x:100.03 y:616.43 w:56.41 h:8.11 weight:none fontsize:9 |
| | face:TimesNewRomanPSMT value:”Ft Jackson SC” |
| [270] | line:174 x:110.58 y:648.89 w:82.65 h:8.11 weight:none fontsize:9 |
| | face:TimesNewRomanPSMT value:”Clerical Bookkeeping” |
| [271] | line:176 x:110.58 y:662.83 w:68.44 h:8.11 weight:none fontsize:9 |
| | face:TimesNewRomanPSMT value:”Office Procedures” |
| [272] | line:178 x:110.58 y:676.80 w:27.29 h:8.11 weight:none fontsize:9 |
| | face:TimesNewRomanPSMT value:”Typing” |
| [273] | line:180 x:407.81 y:648.89 w:19.15 h:8.11 weight:none fontsize:9 |
| | face:TimesNewRomanPSMT value:”3 SH” |
| [274] | line:182 x:407.81 y:662.83 w:19.15 h:8.11 weight:none fontsize:9 |
| | face:TimesNewRomanPSMT value:”2 SH” |
| [275] | line:184 x:407.81 y:676.80 w:19.15 h:8.11 weight:none fontsize:9 |
| | face:TimesNewRomanPSMT value:”2 SH” |
| [276] | line:186 x:511.25 y:648.89 w:5.77 h:8.11 weight:none fontsize:9 |
| | face:TimesNewRomanPSMT value:”L” |
| [277] | line:188 x:511.25 y:662.83 w:5.77 h:8.11 weight:none fontsize:9 |
| | face:TimesNewRomanPSMT value:”L” |
| [278] | line:190 x:511.25 y:676.80 w:5.77 h:8.11 weight:none fontsize:9 |
| | face:TimesNewRomanPSMT value:”L” |
| [279] | line:192 x:100.68 y:556.82 w:55.61 h:8.11 weight:none fontsize:9 |
| | face:TimesNewRomanPSMT value:”(10/00)(10/00)” |
| [280] | line:194 x:100.03 y:694.67 w:46.16 h:8.11 weight:none fontsize:9 |
| | face:TimesNewRomanPSMT value:”(8/88)(8/88)” |
| [281] | line:262 x:266.37 y:425.24 w:7.35 h:8.11 weight:none fontsize:9 |
| | face:TimesNewRomanPSMT value:”to” |
| [282] | line:264 x:266.37 y:579.38 w:7.35 h:8.11 weight:none fontsize:9 |
| | face:TimesNewRomanPSMT value:”to” |
| [283] | line:266 x:266.37 y:714.20 w:7.35 h:8.11 weight:none fontsize:9 |
| | face:TimesNewRomanPSMT value:”to” |

As can be observed from the changes in positions for the text elements 201-283 in the order shown in Table 2, the text elements 201-283 are encoded in the electronic document 100 in an order not corresponding to the vertical positions, or a human reading order (for example, left-to-right, top-to-bottom), of the text elements 201-283 according to their intended visual appearance. For example, this is illustrated well by the order and distribution of positions for the text elements 201-227. Additionally, the electronic document 100 includes arrangements of text elements with similar visual layouts and presenting similar types of information, such a first subset of 22 text elements with y values between 400 and 570 and a second subset of 19 text elements with y values between 570 and 700, that might be expected to be encoded in a predictable order in a well-structured document format, the encodings of these text elements are each ordered within the electronic document 100 in different ways from one another. It is noted that in some implementations, a font may be indicated as a font family. For example, all of the fonts indicated in Table 2 may be identified as members of a “Times New Roman” font family.

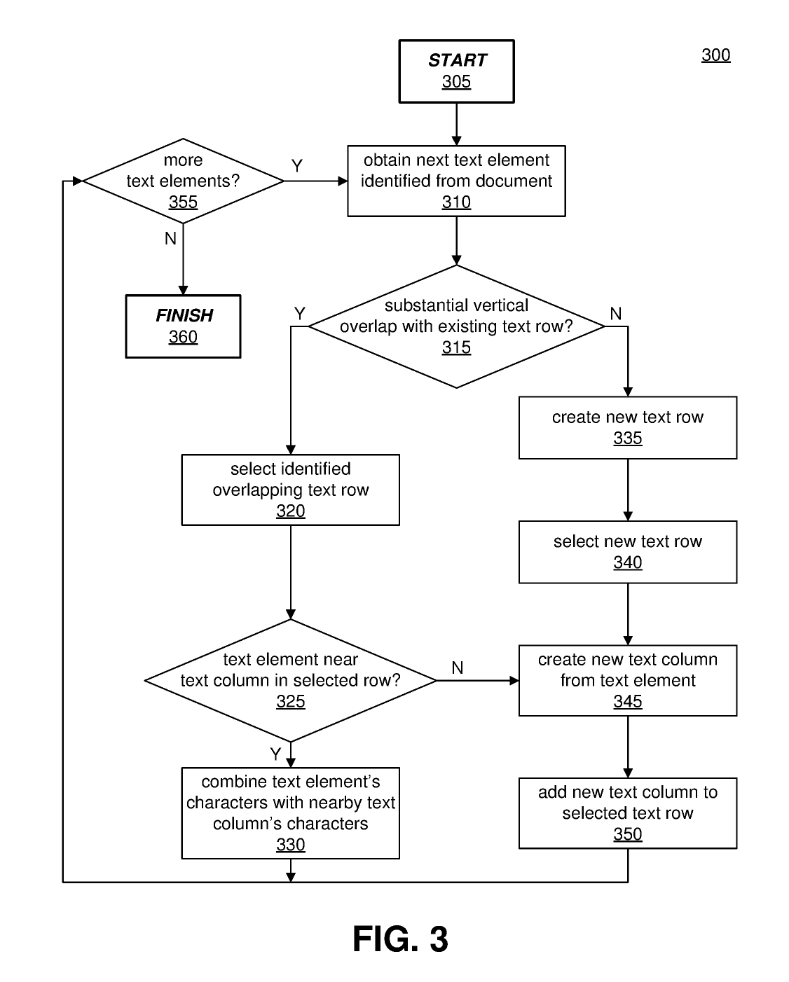

FIG. 3 illustrates an example of a process 300 for using text elements identified from an electronic document, such as the text elements 201-283 in FIGS. 2A and 2B, to generate associated text rows and text columns with characters and positions based on the characters and positions of the identified text elements. Each of the resulting text rows is generated for a respective subset of one or more of the text elements based on at least the vertical positions for the subset of the text elements, and each text cell is generated from and has the characters from one or more of the subset of text elements used to generate its associated text row. In this disclosure, the text rows may also be referred to more simply as “rows,” and the text columns may also be referred to as “text cells,” “text blocks,” or more simply as “columns.” It is noted that various operations described in connection with FIG. 3 may be rearranged, combined, modified, and/or supplemented with additional operations and also be suitable for implementing the techniques described herein.

The process 300 begins at 305 with an empty set of text rows, to which generated text rows will be added during the process 300. In some implementations, the text rows are maintained in order according to vertical position, or otherwise accessible according to vertical position. For example, the text rows may be maintained in a sorted array, linked list, or tree data structure. At operation 310, a text element identified from the electronic document is obtained. For example, much as described above for text elements 201-283 in FIGS. 2A and 2B. The text element obtained at 310 may be referred to as the “current text element” for the remaining operations 315-355 illustrated in FIG. 3.

At operation 315, a determination is made whether there is a substantial vertical overlap of the current text element with any already existing text row. By not requiring full or exact overlap between text elements and associated text rows, multiple text elements with minor differences in vertical positioning may be associated and used together to generate a single text row. Such minor differences can be seen between text elements 202 and 203 and text element 249 and 253 in Table 2, for example.

Various approaches may be used for the determination whether there is a substantial vertical overlap, with configurable values. In some implementations, a threshold percentage overlap of a vertical range for the current text element with a vertical range for a text row may be specified and, in some examples, configured. As shown in Table 2, the current text element may have a vertical position (“y” in Table 2) and a height (“h” in Table 2) from which a vertical range for the current text element may be determined. For example, the text element 203, with y=48.97 and h=9.11, would have vertical range from y=39.86 (a top of text element 203) to y=48.97 (the already noted vertical position). Likewise, each text row has a vertical range (for example, using similar vertical position and height values). Whether a threshold portion of the current text element overlaps with a text row may be determined from the vertical ranges. In some examples, a threshold amount of overlap is around 80%, although this amount may be adjusted. By using a threshold amount less than 100%, minor differences in vertical positioning will not prevent text elements from being associated with a single text row.

Other implementations are also effective for determining whether there is a substantial vertical overlap. In some implementations, a threshold difference between a vertical position (for example, corresponding to a baseline) of the current text element and a vertical position of a text row may be used. The threshold difference may be determined based on a font size or height for the current text element and/or text row. In some examples, a threshold difference may be around 20% of a height for the current text element, although this amount may be adjusted.

If at 315 an existing text row with the required amount of overlap is identified (“Y” at 315), process 300 continues to operation 320, in which the identified text row is selected as the text row associated with the current text element. From there, the process 300 continues to operation 325, which determines if the selected text row includes an existing text column that is positioned near the current text element in the horizontal direction. Much as with determining a vertical range in operation 315, a first horizontal range can be determined for the current text element, and a second horizontal range likewise determined for text elements included in the selected text row. In some implementations, a threshold distance may be used, approximately equal to a width of two adjacent space characters in a font (typeface, weight, and font size) for the current text element, multiplied or otherwise adjusted by any extra character spacing, word spacing, or other relevant graphics state or text state parameters.

If at 325 it is determined that the current text element is near a text column included in the selected text row (“Y” at 325), the process 300 continues to operation 330, in which the characters of the current text element are combined with the characters of the nearby text column. Depending on the relative horizontal position of the nearby text column, the characters from the current text element are prepended (where the nearby text column is to the right of the current text element) or appended (where the nearby text column is to the left) to the characters of the nearby text column. In some circumstances, based on an amount of distance between the current text element and the nearby text column, one or even two space characters may be added to the nearby text column as well, between the characters of the current text element and the nearby text column. The horizontal range and, in some circumstances, the vertical range of the nearby text column are updated to include the horizontal and vertical ranges of the current text element. In some circumstances (for example, where the selected text row did not entirely overlap the current text element), the horizontal range and/or vertical range of the selected text row are updated to include the horizontal and vertical ranges of the current text element.

In some circumstances, it may be determined that, for the selected text row, a first text column is close to a left side of the current text element and a second text column is close to a right side of the current text element. If so, the characters from text first text column, the current text element, and the second text column are combined into a single text element. For example, the characters from the current text element and the second text column may be added to the first text column, various information updated for the first text element (for example, a width), and the second text column removed from the selected text row. The above combining of characters of the current text element with characters of one or more existing text elements may involve including additional characters into an existing text element, or may involve combining the characters into a text element that replaces one of the existing text elements.

If at 315 it is determined there is no substantial vertical overlap of the current text element with any of the already existing text rows (“N” at 315), process 300 continues to operation 335, in which a new text row is created for the current text element. It is noted that not every one of the already existing rows has to be assessed at 315 for this determination to be made (for example, arrangement of the text rows in a data structure may allow a fraction of the text rows to be evaluated). Then, at operation 340, the new text row created at 335 is selected as the text row associated with the current text element, much as in operation 320.

The process 300 continues to operation 345 either from operation 340, or operation 325 if it is determined that the current text element is not near a text column included in the selected text row (“N” at 325). In operation 345, a new text column is created with the characters of the current text element, and also given properties from the current text element, such as, but not limited to, its vertical and horizontal ranges, typeface, font weight, and font size. From there, in operation 350 the new text column created in operation 345 is added to the selected text row. In some circumstances, the horizontal range and/or vertical range of the selected text row are updated to include the horizontal and vertical ranges of the current text element. From both operations 330 and 350, the process 300 continues to operation 355, which determines whether more text elements remain to be used to generate text rows. If so (“Y” at 355), the process 300 returns to operation 310, beginning processing of the next text element. If not (“N” at 355), the process 300 finishes at 360.

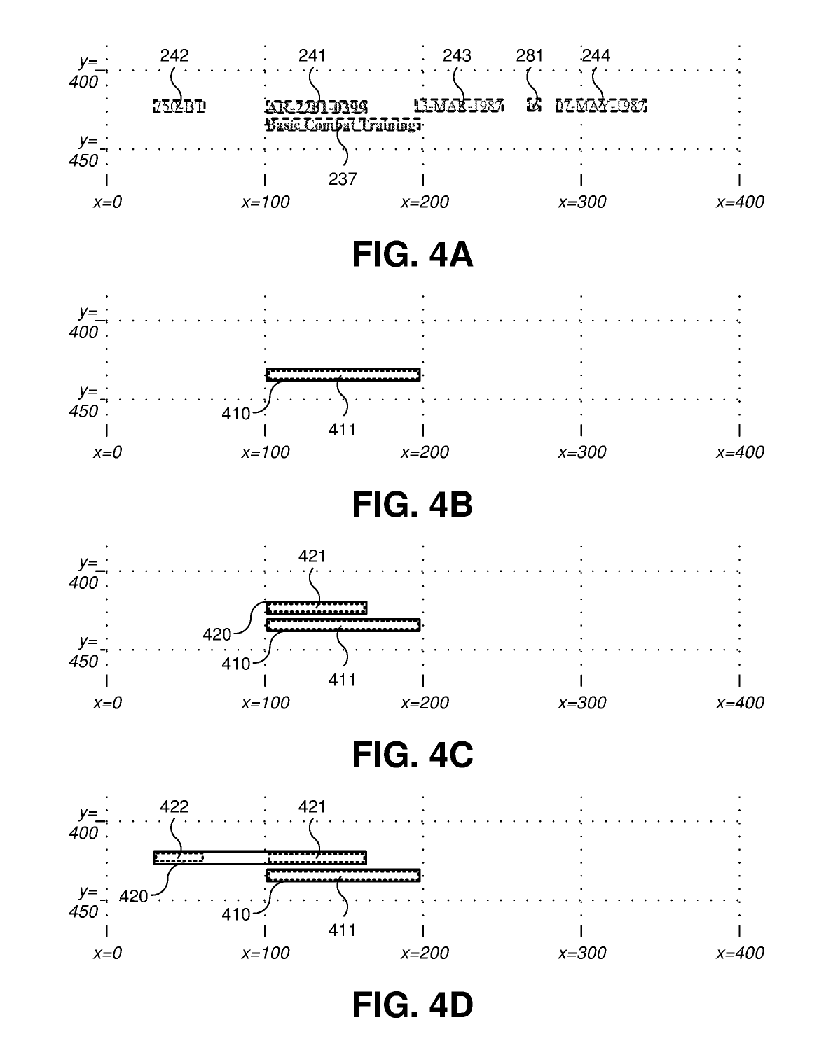

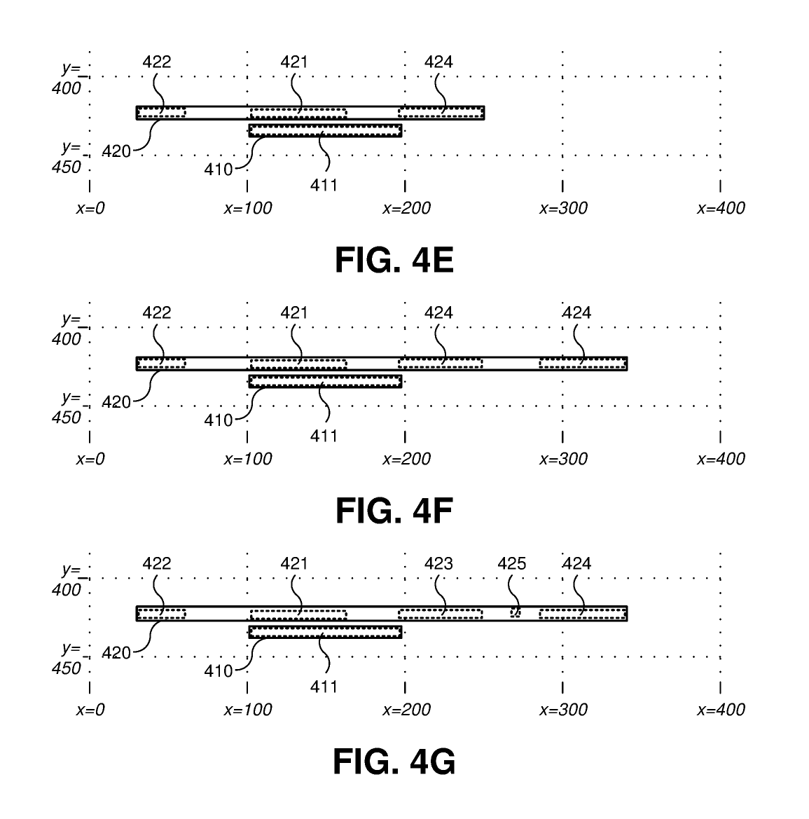

FIGS. 4A-4G illustrate an example in which, much as described in connection with FIG. 3, text rows 410 and 420 and text columns 421, 422, 423, 424, and 425 are generated based on associated text elements 237, 241, 242, 243, 244, and 281 shown in FIGS. 2B and 4A. FIG. 4A illustrates vertical and horizontal ranges and characters for the text elements 237, 241, 242, 243, 244, and 281 being processed in FIGS. 4B-4G, in an order corresponding to their reference numerals (which corresponds to the order in which they were encoded in, and/or identified from, electronic document 100).

In FIG. 4B, no existing text row is identified as overlapping text element 237. As a result, a new text row 410 is created, and a new text column 411 is created based on the text element 237 (for example, having the characters of the text element 237), and included in text row 410. Vertical and horizontal ranges for both the new text row 410 and the new text column 411 are the same as the vertical and horizontal ranges of text element 237.

In FIG. 4C, no existing text row is identified as overlapping text element 241. As a result, a new text row 420 is created, and a new text column 421 is created based on the text element 241, and included in text row 420. Vertical and horizontal ranges for both the new text row 420 and the new text column 421 are the same as the vertical and horizontal ranges of text element 241.

In FIG. 4D, a vertical range of the text row 420 created in FIG. 4C entirely overlaps a vertical range of the text element 242, and accordingly the text row 420 is selected as being associated with the text element 242. The text column 421 is not near the text element 242. As a result, a new text column 422 is created based on the text element 242, and included in text row 420. The horizontal range of the text row 420 is extended to the left to include the horizontal range of the text element 242.

In FIG. 4E, a vertical range of the text row 420 overlaps 95% of the vertical range of the text element 243, and accordingly the text row 420 is selected as being associated with the text element 243. Neither of the text columns 421 and 422 included in the text row 420 are near the text element 243. As a result, a new text column 423 is created based on the text element 243, and included in text row 420. The horizontal range of the text row 420 is extended to the right to include the horizontal range of the text element 243, and the vertical range of the text row 420 is extended upward to include the vertical range of the text element 243.

In FIG. 4F, a vertical range of the text row 420 entirely overlaps a vertical range of the text element 244, and accordingly the text row 420 is selected as being associated with the text element 244. None of the text columns 421, 422, and 423 included in the text row 420 are near the text element 244. As a result, a new text column 424 is created based on the text element 244, and included in text row 420. The horizontal range of the text row 420 is extended to the right to include the horizontal range of the text element 244.

In FIG. 4F, a vertical range of the text row 420 overlaps 94% of the vertical range of the text element 281, and accordingly the text row 420 is selected as being associated with the text element 281. None of the text columns 421, 422, and 423 included in the text row 420 are near the text element 281. As a result, a new text column 425 is created based on the text element 281, and included in text row 420. The vertical range of the text row 420 is extended upward to include the vertical range of the text element 281.

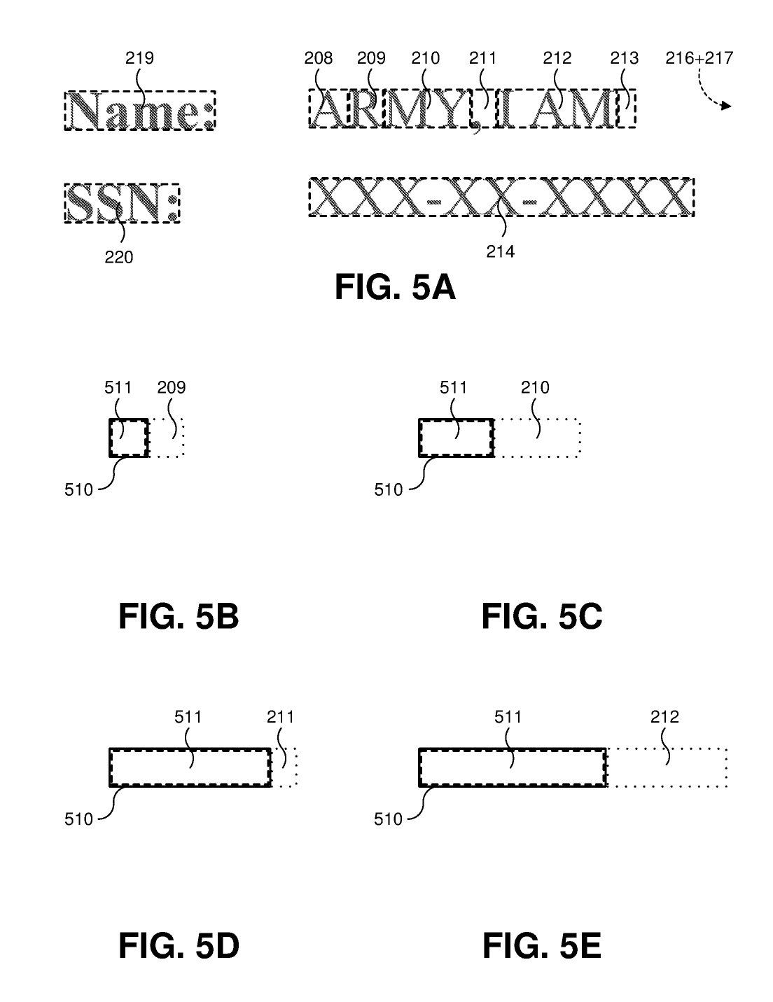

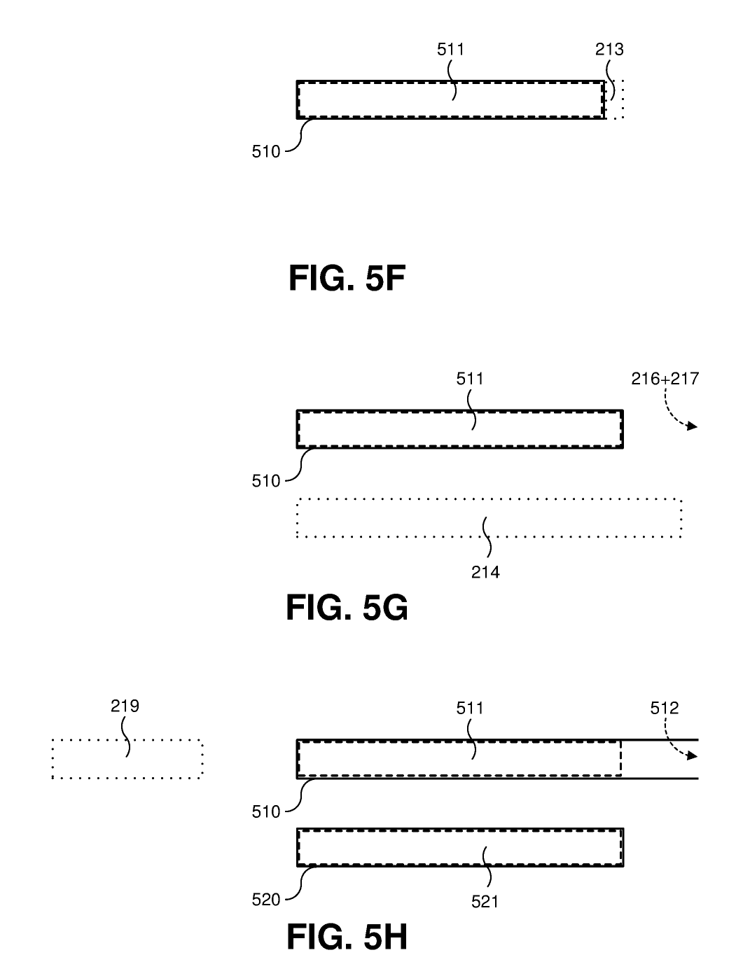

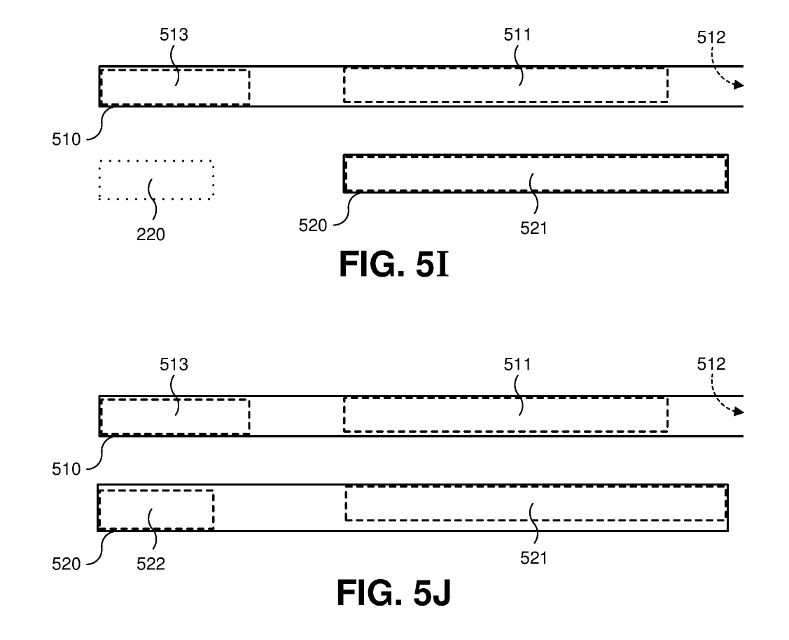

FIGS. 5A-5J illustrate another example in which, much as described in connection with FIG. 3, text rows 510 and 520 and text columns 511, 512, 513, 521, and 522 are generated based on associated text elements 208-214, 216, 217, 219, and 220 shown in FIGS. 2B and 5A, including concatenation of characters from multiple text elements 208-213 into a single text column 511. FIG. 5A illustrates vertical and horizontal ranges and characters for the text elements 208-214, 219, and 220. Vertical and horizontal ranges and characters are not shown for the text elements 216 and 217, as they are not within the horizontal ranges illustrated within FIGS. 5A-5J. The text elements 208-214, 216, 217, 219, and 220 are processed in FIGS. 5B-5J in an order corresponding to their reference numerals (which corresponds to the order in which they were encoded in, and/or identified from, electronic document 100).

In FIG. 5B, no existing text row is identified as overlapping text element 208. As a result, a new text row 510 is created, and a new text column 510 is created based on the text element 208 (for example, having the single character “A” of the text element 208), and included in text row 510. Vertical and horizontal ranges for both the new text row 510 and the new text column 511 are the same as the vertical and horizontal ranges of text element 208.

In FIG. 5C, a vertical range of the text row 510 created in FIG. 5B entirely overlaps a vertical range of the text element 209, and accordingly the text row 510 is selected as being associated with the text element 209. The text column 511 is essentially adjacent to, and on the left side of, the text element 209. As a result, the character “R” of the text element 209 is appended to the text column 511 (with the text column 511 then having the characters “AR”). The horizontal ranges of the text row 510 and the text column 511 are extended to the right to include the horizontal range of the text element 209. In FIGS. 5D, 5E, 5F, and 5G, similar determinations are made for respective text elements 210, 211, 212, and 213, resulting in their characters being successively appended to the text column 511 (with the text column 511 having the characters “ARMY, AM I” in FIG. 5G. The horizontal ranges of the text row 510 and the text column 511 are extended to the right to include the horizontal ranges of the text elements 210, 211, 212, and 213.

In FIG. 5H, the text elements 214, 216, and 217 have been processed. For the text element 214, a new text row 520 and text column 521 have been added, much as in FIGS. 4B, 4C, and 5B. For the text element 216, a vertical range of the text row 510 overlaps 97% of the vertical range of the text element 216, and as a result a new text column 512 (not visible in FIGS. 5H-5J) has been added to the text row 510, much as described in FIG. 4E. The vertical range of the text row 510 has also been extended upward to include the horizontal range of the text element 216. The text column 512 is essentially adjacent to, and on the left side of, the text element 217. As a result, the space character “ ” of the text element 216 is appended to the text column 512 (with the text column 512 then having the characters “University of XXXXXXX”), much as in FIGS. 5C-5G. In FIGS. 5I and 5J, new text columns 513 and 522 are added respectively to text rows 510 and 520 for the respective text elements 219 and 220, much as in FIG. 4D.

It is expressly noted that although all of the text elements for the first page 110 are shown in FIGS. 2A and 2B and Table 2, this is not intended to imply an order of processing in which all text elements, whether for one or more pages of an electronic document, are first identified before proceeding to other document processing operations, such as the examples described above in connection with FIGS. 4A-5J. In some implementations, text rows are generated without regard to the extent or order in which the text elements have been or are being identified from the electronic document. In some implementations, text rows are generated and updated incrementally in the course of their associated text elements being identified in an electronic document. For example, identification of the text elements shown in FIG. 4A and generation of their corresponding text rows might proceed in the following order:
Identify text element 237 from a corresponding encoding in electronic document 100
Create new text row 410 and new text column 411 based on text element 237
[text elements 238, 239, and 240 identified and used to generate associated text rows]
Identify text element 241 from a corresponding encoding in electronic document 100
Create new text row 420 and new text column 421 based on text element 241
Identify text element 242 from a corresponding encoding in electronic document 100
Create new text column 422 and include in text row 420 based on text element 241
. . . .
   Various other approaches may be used that likewise do not first identify all of the text elements for one or more pages before proceeding. For example, a producer-consumer design pattern might be used for concurrent identification of text elements and generation of corresponding text rows among multiple threads, processors, and/or systems.

In view of the visual appearance of a page of a PDF document being unaffected by operations specified for the other pages in the PDF document, in some implementations, page content stream objects can be processed out of page number sequence, such as in the order they are presented in the PDF document. For example, page N+1 may be processed before page N, such as due to page N+1 being presented in an electronic document before page N. In some implementations, multiple pages of electronic document 100 may be processed in parallel.

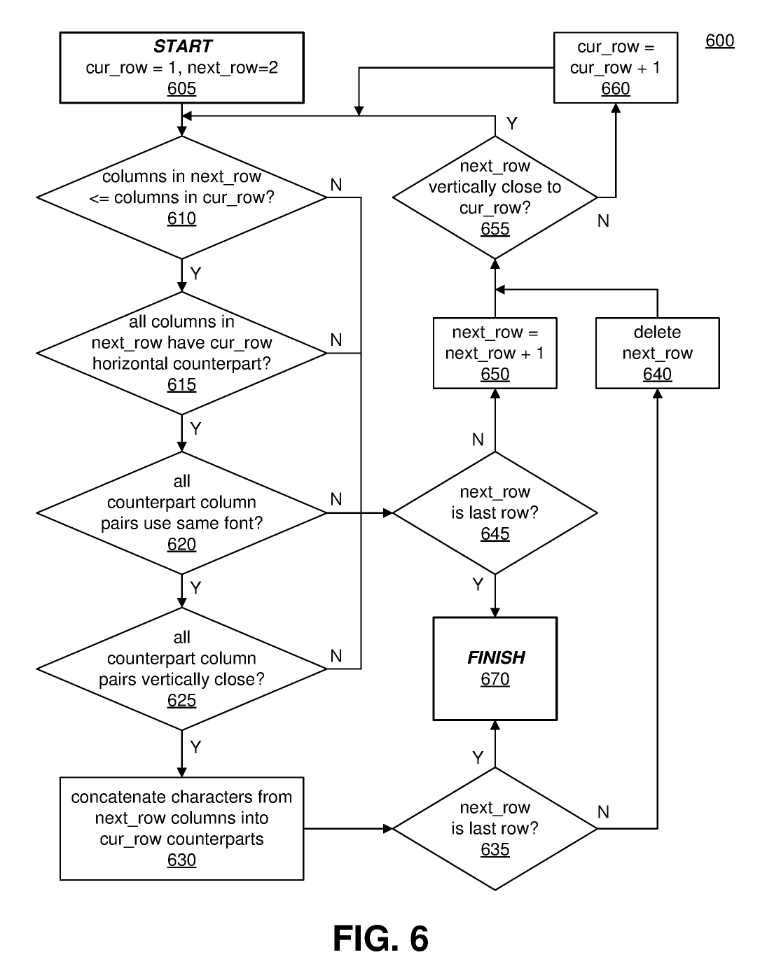

FIG. 6 illustrates an example of a process 600 for consolidating text rows and text columns generated from an electronic document, such as text rows generated according to the process 300 described in connection with FIG. 3. However, the process 600 is expressly not limited to such text rows. In most instances, the process 600, and variations thereof, perform an effective, and efficient consolidation of multiple text columns from respective text rows into a single text column that in most instances correctly encapsulates a discrete item of text information. Examples of such items include, but are not limited to, text paragraphs and tabular text item that initially span multiple text rows. Further, the process 600 achieves these results while remaining document content and format agnostic; in other words, the text row consolidation can be performed without an initial identification of the type of document, types of text information included in the document, or a visual layout used to present the text information. As a result, process 600 is both broadly applicable across various documents, robust against changes or variations introduced into a particular document structure over time, and consolidates text information into units that support more robust downstream processing in the face of such changes or variations.

In the example illustrated in FIG. 6, the process 600 assumes all of the initial text rows have been generated for an electronic document, that rows have been arranged according to their vertical position from top to bottom (or beginning to end), and proceeds through the generated rows from the top of the document to the bottom, and proceeding through pages of a multipage electronic document in page order. However, other variations and alternatives may be used to implement the described techniques. At the start of process 600, the operation 605 selects the first and topmost text row (with an index or row number of 1) as a “current row” (designated “cur_row” in FIG. 6) and selects the next text row according to the vertical arrangement (with an index or row number of 2) as a “next row” (designated “next_row” in FIG. 6) for succeeding operations.

A number of conditions and/or evaluations may be performed to determine whether the next row is suitable for consolidation with the current row, as illustrated in FIG. 6. Operation 610 determines whether the number of text columns included in the next row are less than or equal to the number of text columns included in the current row. Operation 615 determines whether each of the text columns included in the next row has a counterpart text column included in the current row with a horizontal position within a horizontal distance threshold (which may be configurable). An example horizontal distance threshold is approximately 3 points (or approximately 1.06 millimeters).

One or more arrangements of horizontal positions may be evaluated in operation 615 to determine if this determination is met, including, for example, horizontal positions corresponding to the left sides (which may correspond to minimum x values in some examples, such as in FIGS. 1A-1E) of the text columns (useful for identifying left-justified text counterparts), horizontal positions corresponding to the centers of the text columns (useful for identifying centered text counterparts, which are often encountered with tabular text information), and/or horizontal positions corresponding to the right sides of the text columns (for occasional occurrences of right-justified text counterparts). In some implementations, which ones of these left, center, and/or right positions are used may be biased and determined based on which of multiple text columns included in either the current row or the next row are being evaluated. For example, a rightmost text column may be more likely to be right-justified. In some implementations, which ones of these left, center, and/or right positions are used may be biased and determined based on which ones were applied in a recent row consolidation (which may be further based on horizontal positioning of previously consolidated text columns relative to horizontal positioning of text elements currently being evaluated). If a positive determination is made in operation 615 (“Y,” in 615), each text column in the next row has been paired with a counterpart text column in the current row.

Operation 620 determines if all of the pairs of counterpart text columns from the current row and the next row use the same font (typeface, weight, and/or font size). Operation 625 determines if all of the pairs of counterpart text columns from the current row and the next row are arranged within a vertical distance threshold. A vertical distance (which may also be referred to as a “vertical displacement”) between two text columns may be measured, for example, as a distance between a bottom of a text column in the current row and a top of it counterpart text column in the next row, or as a distance between baselines, bottoms, or tops of the two text columns. The vertical distance threshold may be determined based on at least a font size and/or a line spacing parameter of a text state that applies to one or more text elements used to generate one of the counterpart text columns.

In the example illustrated in FIG. 6, if any of the determinations made by operations 610, 615, 620, or 625 is negative or fails (“N” in any of 610, 615, 620, or 625), the process 600 proceeds to operation 645 described below. However, if all of the determinations made by operations 610, 615, 620, or 625 are positive (“Y” in all of 610, 615, 620, and 625), then the process instead proceeds to operation 630. In operation 630, for each text column included in the next row, the characters from the text column are concatenated with (for example, appended to) the characters of the counterpart text column included in the current row. In some examples, a newline character (indicated using the two character sequence “\n” in the below Table 3) or another character is also appended between the characters of the two text columns, to indicate the occurrence and location of consolidation for downstream processing (although other approaches may be used that do not introduce additional characters, such as an index or indices for character positions at which text for a consolidated text column begins). A vertical range and/or horizontal range of the counterpart text column included in the current row is extended to include the vertical and horizontal ranges of the text column of the next row that is being consolidated. Also, a vertical range and/or a horizontal range of the current row is also extended to include the vertical and horizontal ranges of all of the text columns of the next row that are being consolidated in operation 630. After the consolidation of operation 630, at operation 635 a determination is made whether the next row (which was consolidated with the current row in operation 630) is the last row generated for the electronic document. If so (“Y” in 635), the process 600 is finished at 670, as no more rows remain to be processed. If not (“N” in 635), operation 640 deletes the next row (which was consolidated with the current row), allowing the row thereafter to automatically before the next row, and the process 600 continues at 600.

In operation 645 (reached by one of the determinations for operations 610, 615, 620, or 625 being negative), 635 a determination is made whether the next row is the last row generated for the electronic document, much as in operation 645. If so (“Y” in 645), the process 600 is finished at 670, as no more rows remain to be processed. If not (“N” in 645), in operation 650 the next row is advanced to the following row (for example, an index in incremented by one), and process 600 continues to operation 655.

In operation 655, a determination is made whether the next row is vertically close to the current row. This may be done in much the same way as in operation 625. If the determination is negative (“N” in 655), the current row is advanced to the following row (for example, an index is incremented by one). Whether from operation 655 or 660, the process 600 continues, performing the determinations of operations 610, 615, 620, and 625 for the new current row and/or next row.

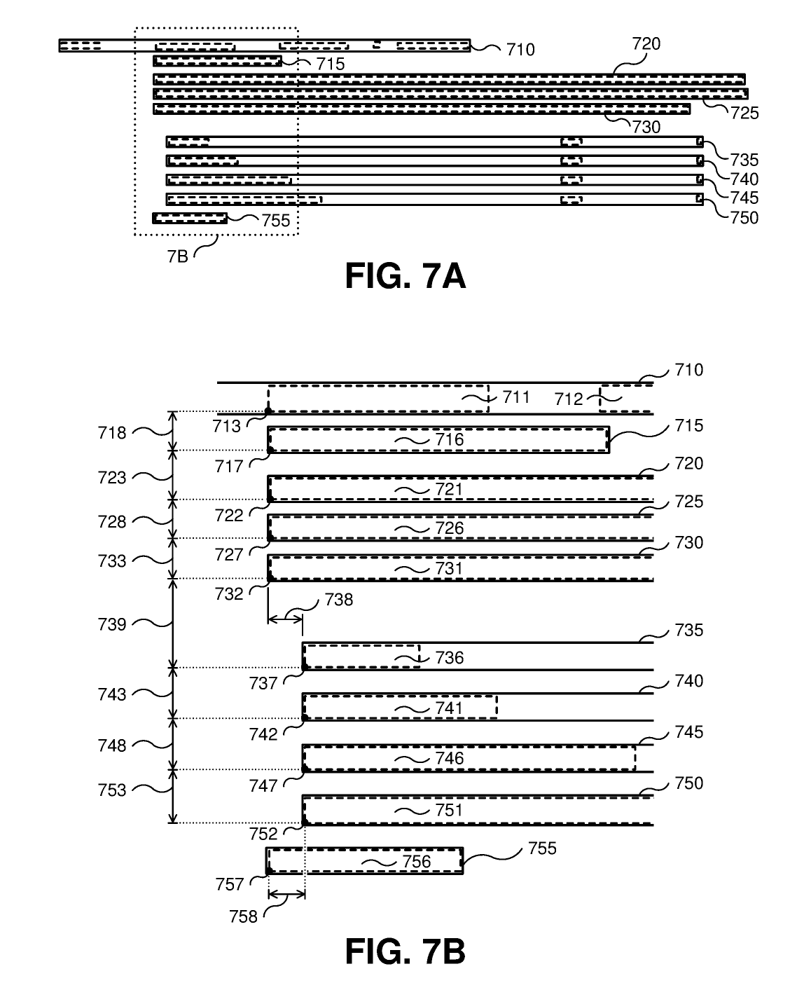

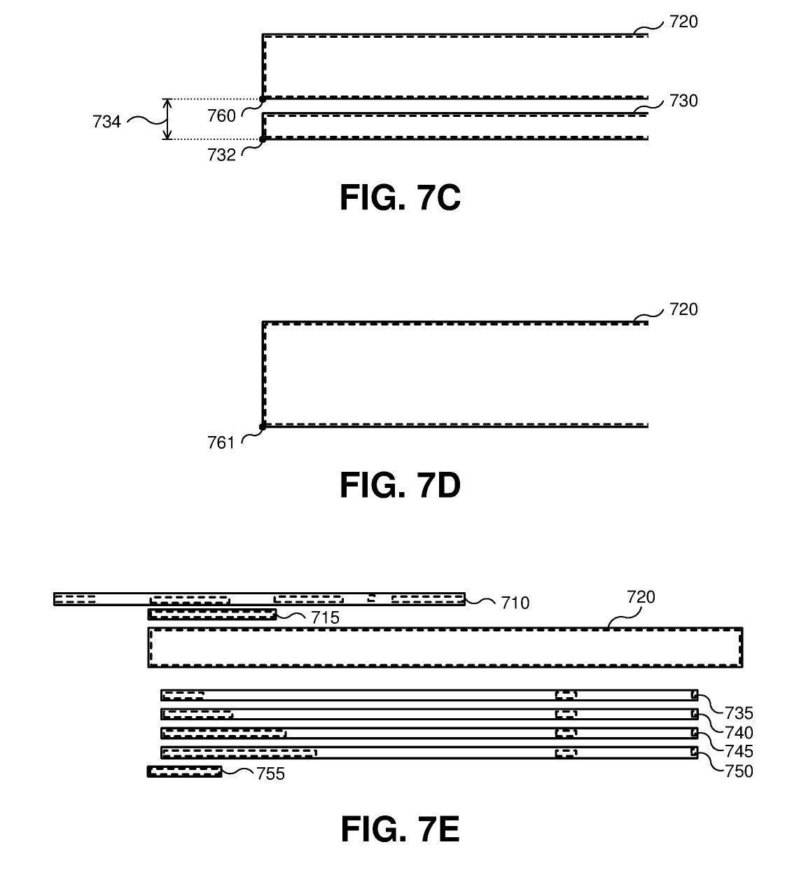

FIGS. 7A-7E illustrate an example in which, much as described in connection with FIG. 6, row consolidation is performed for multiple initial text rows 710, 715, 720, 725, 730, 735, 740, 745, 750, 755, resulting in consolidation of characters from two text rows 725 and 730 into a different preceding text row 720. FIG. 7A illustrates vertical and horizontal ranges for the text rows 710, 715, 720, 725, 730, 735, 740, 745, 750, 755 (corresponding to text elements with y values between 400 and 570 for the first page 110 shown in FIG. 2B) being processed in FIGS. 7B-7E.

FIG. 7B shows a magnified view of the portion of FIG. 7A labeled “7B.” FIG. 7B illustrates text row 710 and text columns 711 and 712 included therein with a position 713 for text column 711, text row 715 and a corresponding text column 716 with a position 717, text row 720 and a corresponding text column 721 with a position 722, text row 725 and a corresponding text column 726 with a position 727, text row 730 and a corresponding text column 731 with a position 732, text row 735 and a corresponding text column 736 with a position 737, text row 740 and a corresponding text column 741 with a position 742, text row 745 and a corresponding text column 746 with a position 737, text row 750 and a corresponding text column 751 with a position 752, and text row 755 and a corresponding text column 756 with a position 757.

Most of the text rows 710, 715, 720, 725, 730, 735, 740, 745, 750, 755 are not consolidated. For example, text row 715 is not consolidated into text row 710 due to vertical distance 718 between positions 713 and 717 exceeding a vertical distance threshold, much as discussed for operation 625 in FIG. 6. Likewise, the vertical distances 723, 739, 743, 748, and 753 exceed respective vertical distance thresholds, resulting in text rows 720, 735, 740, 745, and 750 not being consolidated into text rows above them. Additionally, the horizontal distances 738 and 758 significantly exceed a horizontal distance threshold, much as discussed for operation 615 in FIG. 6, resulting in text row 755 not being consolidated into text row 750, and providing another failed determination for the prospect of consolidating text row 735 into a text row above text row 735.

However, with text rows 720 and 725 respectively handled as the “current row” and “next row” described in connection with FIG. 6, text rows 720 and 725, and their associated text elements 721 and 726, satisfy determinations such as the operations 610, 615, 620, and 625. Thus, as illustrated in FIG. 7C, the text row 725 is consolidated into 720, resulting in a new position 760 for the text row 720 (which is the same as the position 727 previously for the text row 725) and a vertical distance 734 between the positions 760 and 732. With the consolidated text row 720 and text row 730 then respectively handled as the “current row” and “next row” described in connection with FIG. 6, text rows 720 and 730, and their associated text elements, satisfy determinations such as the operations 610, 615, 620, and 625. Thus, as illustrated in FIG. 7D, the text row 730 is consolidated into 720, resulting in a new position 761 for the text row 720 (which is the same as the position 732 previously for the text row 730). The initial text rows 725 and 730 have been deleted in the row consolidations, reducing the total number of remaining rows. FIG. 7E illustrates the result of the above row consolidations, in which a paragraph of text initially distributed across three text columns in three text rows has been consolidated into a single text column and text row. This simplifies and reduces computation for downstream processing, as the downstream processing does not require logic directed to identifying and reassembling the original three separate text columns.

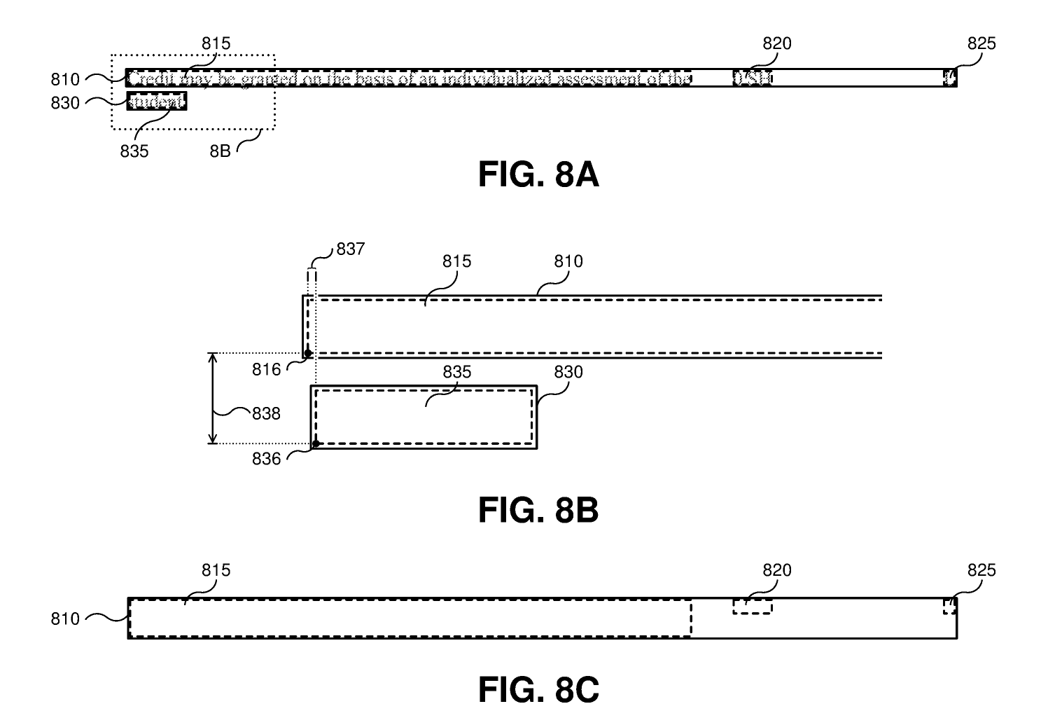

FIGS. 8A-8C illustrate another example in which, much as described in connection with FIG. 6, row consolidation is performed for two initial text rows 810 and 830, resulting in consolidation of one text row 830 into the other text row 810. FIG. 8A illustrates vertical and horizontal ranges and characters for the text rows 810 and 830 and the text columns 815, 820, 825, and 835 therein (corresponding to text elements with y values between 600 and 630 for the second page 120 shown in FIG. 1B) being processed in FIGS. 8B and 8C.

FIG. 8B shows a magnified view of the portion of FIG. 8A labeled “8B.” The text columns 815 and 835 have respective positions 816 and 836, with a horizontal distance 837 and a vertical distance 838 therebetween. The horizontal and vertical distances 837 and 838 satisfy respective horizontal and vertical distance threshold values discussed above in connection with operations 615 and 625 in FIG. 6. With the text row 810 and text row 830 respectively handled as the “current row” and “next row” described in connection with FIG. 6, text rows 810 and 830, and their associated text elements, satisfy determinations such as the operations 610, 615, 620, and 625. Thus, as illustrated in FIG. 8C, the text row 830 is consolidated into 810, including consolidating text column 835 into its counterpart text column 815, and the initial text row 830 is deleted, reducing the total number of remaining rows. FIG. 8C illustrates the result of the above row consolidation, in which a tabular text item initially distributed across two text columns in two text rows had been consolidated into a single text column and text row. This simplifies and reduces computation for downstream processing, as the downstream processing does not require logic directed to identifying and reassembling the original split tabular text item.

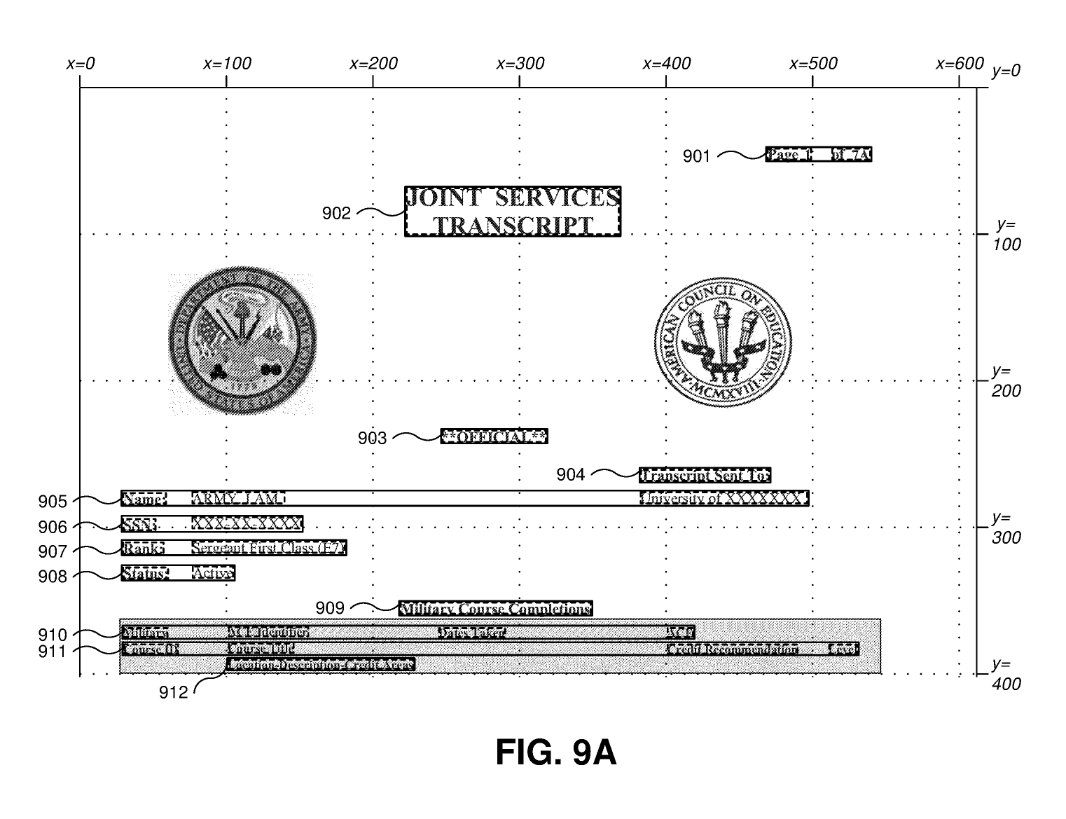

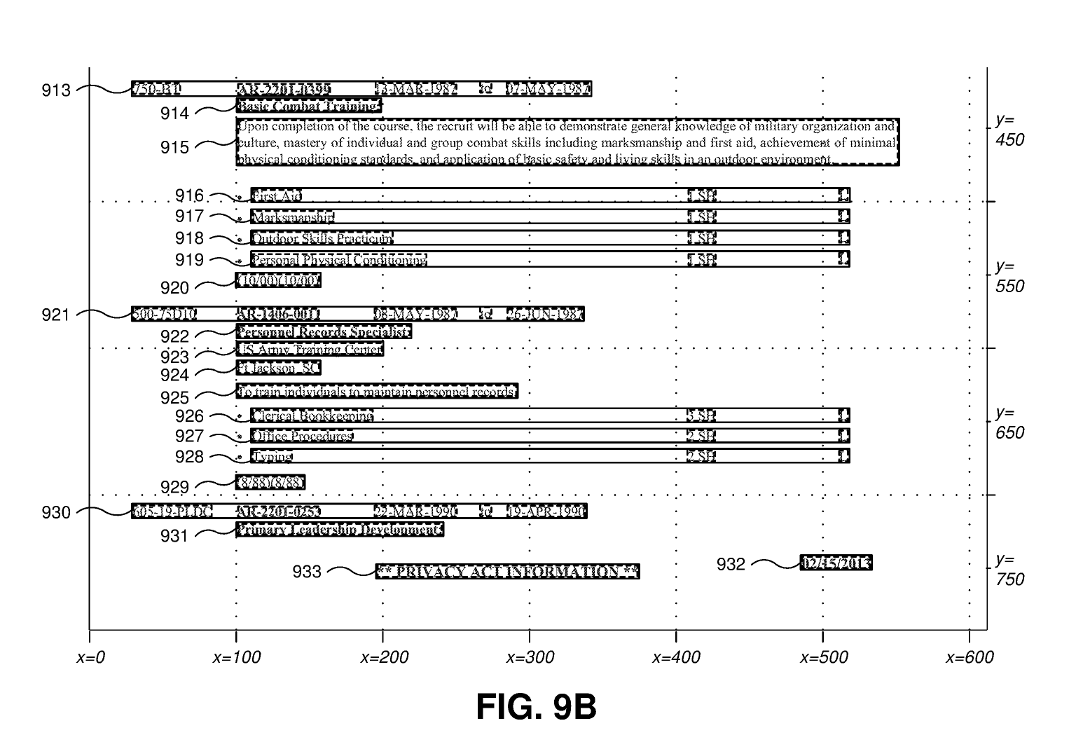

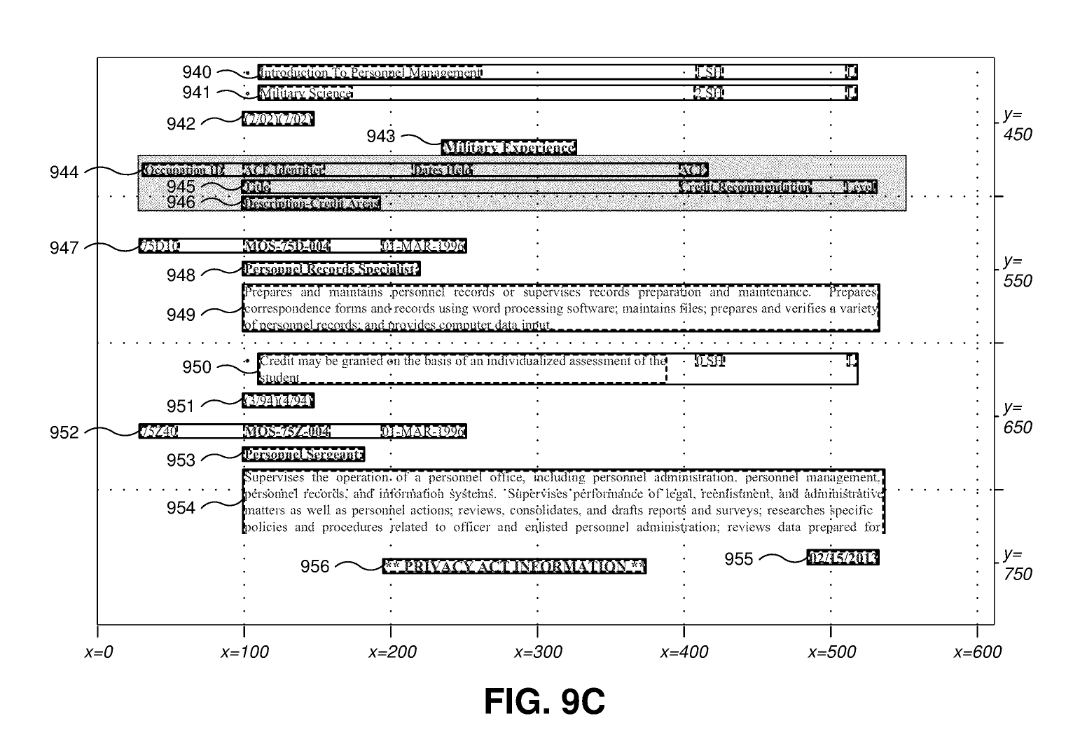

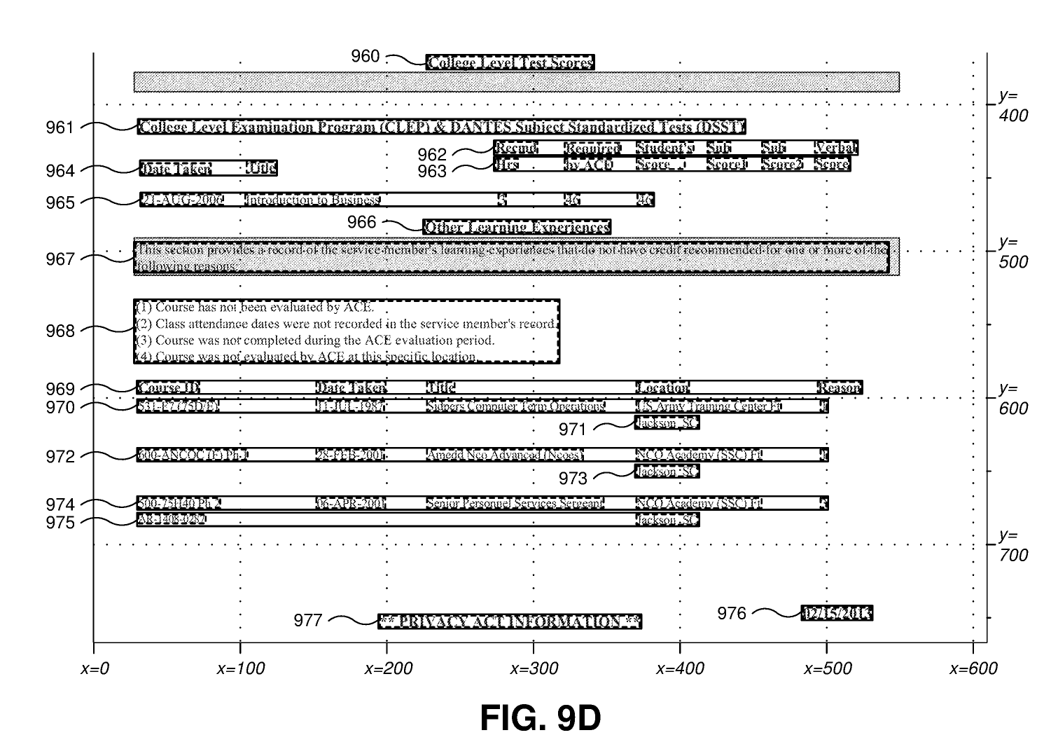

FIGS. 9A and 9B illustrate an example illustrating consolidated text rows 901-933 for the first page 110 illustrated in FIG. 1A, which were generated based on the text elements 201-283 identified for the first page 110 and shown in FIGS. 2A and 2B and Table 2. Table 3, below, provides details about the consolidated rows 901-933. For cross referencing, Table 3 also identifies the original text elements 201-283 in Table 2 and FIGS. 2A and 2B that were used to generate each of the text columns included in the consolidated text rows 901-933.

TABLE 3
Consolidated Rows for First Page 110

```
[row 901: x:469.62 y:48.97 w:69.87 h:9.48]
  [column 1: x:469.62 y:48.97 w:30.12 h:9.48 orig_elements:201,203
      face:VCFALI+TimesNewRoman weight:bold fontsize:10.0
      value:”Page 1”]
  [column 2: x:513.55 y:48.97 w:25.94 h:9.48
  orig_elements:202,206,207
      face:VCFALI+TimesNewRoman weight:bold fontsize:10.0
      value:”of 7A”]
[row 902: x:222.96 y:99.32 w:145.45 h:34.38]
  [column 1: x:222.96 y:99.32 w:145.45 h:34.38 orig_elements:222,223
      face:VCFALI+TimesNewRoman weight:bold fontsize:17.0
      value:”JOINT SERVICES\nTRANSCRIPT”]
[row 903: x:246.88 y:241.60 w:71.57 h:9.11]
  [column 1: x:246.88 y:241.60 w:71.57 h:9.11 orig_elements:224
      face:VCFALI+TimesNewRoman weight:bold fontsize:10.0
      value:”**OFFICIAL**”]
[row 904: x:382.84 y:267.93 w:88.31 h:9.11]
  [column 1: x:382.84 y:267.93 w:88.31 h:9.11 orig_elements:218
      face:VCFALI+TimesNewRoman weight:bold fontsize:10.0
      value:”Transcript Sent To:”]
[row 905: x:29.39 y:284.09 w:454.47 h:9.69]
  [column 1: x:29.39 y:284.09 w:29.42 h:9.11 orig_elements:219
      face:VCFALI+TimesNewRoman weight:bold fontsize:10.0
      value:”Name:”]
  [column 2: x:76.43 y:283.60 w:61.66 h:8.97 orig_elements:208-213
      face:TimesNewRoman weight:none fontsize:10.0
      value:”ARMY, I AM ”]
  [column 3: x:382.84 y:283.37 w:103.91 h:8.97 orig_elements:216,217
      face:TimesNewRomanPSMT weight:none fontsize:10.0
      value:”University of XXXXXXX ”]
[row 906: x:29.39 y:301.80 w:121.45 h:9.16]
  [column 1: x:29.39 y:301.80 w:22.51 h:9.11 orig_elements:220
      face:VCFALI+TimesNewRoman weight:bold fontsize:10.0
      value:”SSN:”]
  [column 2: x:76.43 y:300.61 w:74.41 h:8.97 orig_elements:214
      face:TimesNewRomanPSMT weight:none fontsize:10.0
      value:”XXX-XX-XXXX”]
[row 907: x:29.39 y:318.07 w:151.21 h:9.73]
  [column 1: x:29.39 y:318.07 w:27.70 h:9.11 orig_elements:221
      face:VCFALI+TimesNewRoman weight:bold fontsize:10.0
      value:”Rank:”]
  [column 2: x:76.43 y:317.31 w:104.17 h:8.97 orig_elements:215
      face:TimesNewRomanPSMT weight:none fontsize:10.0
      value:”Sergeant First Class (E7)”]
[row 908: x:29.39 y:334.80 w:75.11 h:9.42]
  [column 1: x:29.39 y:334.80 w:31.16 h:9.11 orig_elements:227
      face:VCFALI+TimesNewRoman weight:bold fontsize:10.0
      value:”Status:”]
  [column 2: x:76.80 y:334.35 w:27.70 h:8.97 orig_elements:226
      face:TimesNewRomanPSMT weight:none fontsize:10.0
      value:”Active”]
[row 909: x:218.66 y:358.95 w:129.85 h:9.11]
  [column 1: x:218.66 y:358.95 w:129.85 h:9.11 orig_elements:225
      face:VCFALI+TimesNewRoman weight:bold fontsize:10.0
      value:”Military Course Completions”]
[row 910: x:29.39 y:374.88 w:389.48 h:7.22]
  [column 1: x:29.39 y:374.88 w:30.22 h:7.21 orig_elements:228
      face:VCFALI+TimesNewRoman weight:bold fontsize:8.0
      value:”Military”]
  [column 2: x:100.76 y:374.16 w:54.54 h:7.21 orig_elements:230
      face:VCFALI+TimesNewRoman weight:bold fontsize:8.0
      value:”ACE Identifier”]
  [column 3: x:244.88 y:374.87 w:45.56 h:7.21 orig_elements:233
      face:VCFALI+TimesNewRoman weight:bold fontsize:8.0
      value:”Dates Taken”]
  [column 4: x:400.93 y:374.87 w:17.94 h:7.21 orig_elements:234
      face:VCFALI+TimesNewRoman weight: bold fontsize:8.0
      value:”ACE”]
[row 911: x:29.39 y:386.21 w:501.70 h:7.93]
  [column 1: x:29.39 y:386.21 w:37.52 h:7.21 orig_elements:229
      face:VCFALI+TimesNewRoman weight: bold fontsize:8.0
      value:”Course ID”]
  [column 2: x:100.76 y:385.49 w:45.09 h:7.21 orig_elements:231
      face:VCFALI+TimesNewRoman weight: bold fontsize:8.0
      value:”Course Title”]
  [column 3: x:400.94 y:386.20 w:89.47 h:7.21 orig_elements:235
      face:VCFALI+TimesNewRoman weight: bold fontsize:8.0
      value:”Credit Recommendation”]
  [column 4: x:511.26 y:386.20 w:19.83 h:7.21 orig_elements:236
      face:VCFALI+TimesNewRoman weight: bold fontsize:8.0
      value:”Level”]
[row 912: x:100.76 y:396.82 w:126.77 h:7.21]
  [column 1: x:100.76 y:396.82 w:126.77 h:7.21 orig_elements:232
      face:VCFALI+TimesNewRoman weight:bold fontsize:8.0
      value:”Location-Description-Credit Areas”]
[row 913: x:29.39 y:427.09 w:311.32 h:9.96]
  [column 1: x:29.39 y:426.37 w:32.32 h:8.11 orig_elements:242
      face:TimesNewRomanPSMT weight:none fontsize:9.0
      value:”750-BT”]
  [column 2: x:100.75 y:427.09 w:63.48 h:9.11 orig_elements:241
      face:VCFALI+TimesNewRoman weight:bold fontsize:10.0
      value:”AR-2201-0399”]
  [column 3: x:194.06 y:425.69 w:56.14 h:8.11 orig_elements:243
      face:TimesNewRomanPSMT weight:none fontsize:9.0
      value:”13-MAR-1987”]
  [column 4: x:266.37 y:425.24 w:7.35 h:8.11 orig_elements:281
      face:TimesNewRomanPSMT weight:none fontsize:9.0
      value:”to”]
  [column 5: x:284.05 y:425.69 w:56.66 h:8.11 orig_elements:244
      face:TimesNewRomanPSMT weight:none fontsize:9.0
      value:”07-MAY-1987”]
[row 914: x:100.75 y:437.71 w:97.60 h:8.19]
  [column 1: x:100.75 y:437.71 w:97.60 h:8.19 orig_elements:237
      face:VCFALI+TimesNewRoman weight:bold fontsize:9.0
      value:”Basic Combat Training:”]
[row 915: x:100.75 y:473.86 w:449.31 h:30.78]
  [column 1: x:100.75 y:473.86 w:449.31 h:30.78
  orig_elements:238,239,240
      face:TimesNewRomanPSMT weight:none fontsize:9.0
      value:”Upon completion of the course, the recruit will be able to
      demonstrate general knowledge of military organization
      and\nculture, mastery of individual and group combat skills
      including marksmanship and first aid, achievement of
      minimal \nphysical conditioning standards, and application of
      basic safety and living skills in an outdoor environment.”]
[row 916: x:110.58 y:499.13 w:406.44 h:8.79]
  [column 1: x:110.58 y:499.13 w:33.85 h:8.11 orig_elements:245
      face:TimesNewRomanPSMT weight:none fontsize:9.0
      value:”First Aid”]
  [column 2: x:407.81 y:499.13 w:19.15 h:8.11 orig_elements:253
      face:TimesNewRomanPSMT weight:none fontsize:9.0
      value:”1 SH”]
  [column 3: x:511.25 y:498.45 w:5.77 h:8.11 orig_elements:249
      face:TimesNewRomanPSMT weight:none fontsize:9.0
      value:”L”]
[row 917: x:110.58 y:513.60 w:408.11 h:8.79]
  [column 1: x:110.58 y:513.60 w:21.35 h:8.11 orig_elements:246
      face:TimesNewRomanPSMT weight:none fontsize:9.0
      value:”Marksmanship”]
  [column 2: x:407.81 y:513.60 w:19.15 h:8.11 orig_elements:254
      face:TimesNewRomanPSMT weight:none fontsize:9.0
      value:”1 SH”]
  [column 3: x:511.25 y:512.92 w:5.77 h:8.11 orig_elements:250
      face:TimesNewRomanPSMT weight:none fontsize:9.0
      value:”L”]
[row 918: x:110.58 y:528.07 w:406.44 h:8.79]
  [column 1: x:110.58 y:528.07 w:21.35 h:8.11 orig_elements:247
      face:TimesNewRomanPSMT weight:none fontsize:9.0
      value:”Outdoor Skills Practicum”]
  [column 2: x:407.81 y:528.07 w:19.15 h:8.11 orig_elements:255
      face:TimesNewRomanPSMT weight:none fontsize:9.0
      value:”1 SH”]
  [column 3: x:511.25 y:527.39 w:5.77 h:8.11 orig_elements:251
      face:TimesNewRomanPSMT weight:none fontsize:9.0
      value:”L”]
[row 919: x:110.58 y:542.54 w:406.44 h:8.79]
  [column 1: x:110.58 y:542.54 w:21.35 h:8.11 orig_elements:248
      face:TimesNewRomanPSMT weight:none fontsize:9.0
      value:”Personal Physical Conditioning”]
  [column 2: x:407.81 y:542.54 w:19.15 h:8.11 orig_elements:256
      face:TimesNewRomanPSMT weight:none fontsize:9.0
      value:”1 SH”]
  [column 3: x:511.25 y:541.86 w:5.77 h:8.11 orig_elements:252
      face:TimesNewRomanPSMT weight:none fontsize:9.0
      value:”L”]
[row 920: x:100.68 y:556.82 w:55.61 h:8.11]
  [column 1: x:100.68 y:556.82 w:55.61 h:8.11 orig_elements:279
      face:TimesNewRomanPSMT weight:none fontsize:9.0
      value:”(10/00)(10/00)”]
[row 921: x:29.39 y:579.68 w:307.31 h:9.11]
  [column 1: x:29.39 y:579.68 w:43.02 h:8.11 orig_elements:266
      face:TimesNewRomanPSMT weight:none fontsize:9.0
      value:”500-75D10”]
  [column 2: x:100.03 y:579.68 w:57.71 h:9.11 orig_elements:259
      face:VCFALI+TimesNewRoman weight:bold fontsize:10.0
      value:”AR-1406-0011”]
  [column 3: x:194.06 y:579.68 w:56.66 h:8.11 orig_elements:261
      face:TimesNewRomanPSMT weight:none fontsize:9.0
      value:”08-MAY-1987”]
  [column 4: x:266.37 y:579.38 w:7.35 h:8.11 orig_elements:282
      face:TimesNewRomanPSMT weight:none fontsize:9.0
      value:”to”]
  [column 5: x:284.77 y:579.68 w:51.93 h:8.11 orig_elements:263
      face:TimesNewRomanPSMT weight:none fontsize:9.0
      value:”26-JUN-1987”]
[row 922: x:100.03 y:591.73 w:119.10 h:8.19]
  [column 1: x:100.03 y:591.73 w:119.10 h:8.19 orig_elements:257
      face:VCFALI+TimesNewRoman weight: bold fontsize:9.0
      value:”Personnel Records Specialist:”]
[row 923: x:100.03 y:603.74 w:98.89 h:8.11]
  [column 1: x:100.03 y:603.74 w:98.89 h:8.11 orig_elements:268
      face:TimesNewRomanPSMT weight:none fontsize:9.0
      value:”US Army Training Center”]
[row 924: x:100.03 y:616.43 w:56.41 h:8.11]
  [column 1: x:100.03 y:616.43 w:56.41 h:8.11 orig_elements:269
      face:TimesNewRomanPSMT weight:none fontsize:9.0
      value:”Ft Jackson SC”]
[row 925: x:100.03 y:632.72 w:191.27 h:8.11]
  [column 1: x:100.03 y:632.72 w:191.27 h:8.11 orig_elements:265
      face:TimesNewRomanPSMT weight:none fontsize:9.0
      value:”To train individuals to maintain personnel records.”]
[row 926: x:110.58 y:648.89 w:406.44 h:8.11]
  [column 1: x:110.58 y:648.89 w:82.65 h:8.11 orig_elements:270
      face:TimesNewRomanPSMT weight:none fontsize:9.0
      value:”Clerical Bookkeeping”]
  [column 2: x:407.81 y:648.89 w:19.15 h:8.11 orig_elements:273
      face:TimesNewRomanPSMT weight:none fontsize:9.0
      value:”3 SH”]
  [column 3: x:511.25 y:648.89 w:5.77 h:8.11 orig_elements:276
      face:TimesNewRomanPSMT weight:none fontsize:9.0
      value:”L”]
[row 927: x:110.58 y:662.83 w:406.44 h:8.11]
  [column 1: x:110.58 y:662.83 w:68.44 h:8.11 orig_elements:271
      face:TimesNewRomanPSMT weight:none fontsize:9.0
      value:”Office Procedures”]
  [column 2: x:407.81 y:662.83 w:19.15 h:8.11 orig_elements:274
      face:TimesNewRomanPSMT weight:none fontsize:9.0
      value:”2 SH”]
  [column 3: x:511.25 y:662.83 w:5.77 h:8.11 orig_elements:277
      face:TimesNewRomanPSMT weight:none fontsize:9.0
      value:”L”]
[row 928: x:110.58 y:676.80 w:406.44 h:8.11]
  [column 1: x:110.58 y:676.80 w:27.29 h:8.11 orig_elements:272
      face:TimesNewRomanPSMT weight:none fontsize:9.0
      value:”Typing”]
  [column 2: x:407.81 y:676.80 w:19.15 h:8.11 orig_elements:275
      face:TimesNewRomanPSMT weight:none fontsize:9.0
      value:”2 SH”]
  [column 3: x:511.25 y:676.80 w:5.77 h:8.11 orig_elements:278
      face:TimesNewRomanPSMT weight:none fontsize:9.0
      value:”L”]
[row 929: 100.03 y:694.67 w:46.16 h:8.11]
  [column 1: x:100.03 y:694.67 w:46.16 h:8.11 orig_elements:280
      face:TimesNewRomanPSMT weight:none fontsize:9.0
      value:”(8/88)(8/88)”]
[row 930: x:29.39 y:714.51 w:308.37 h:9.11]
  [column 1: x:29.39 y:714.51 w:54.04 h:8.97 orig_elements:267
      face:TimesNewRomanPSMT weight:none fontsize:10.0
      value:”605-19-PLDC”]
  [column 2: x:100.03 y:714.51 w:57.71 h:9.11 orig_elements:260
      face:VCFALI+TimesNewRoman weight:bold fontsize:10.0
      value:”AR-2201-0253”]
  [column 3: x:194.06 y:714.51 w:56.14 h:8.11 orig_elements:262
      face:TimesNewRomanPSMT weight:none fontsize:9.0
      value:”22-MAR-1990”]
  [column 4: x:266.37 y:714.20 w:7.35 h:8.11 orig_elements:283
      face:TimesNewRomanPSMT weight:none fontsize:9.0
      value:”to”]
  [column 5: x:284.77 y:714.51 w:52.99 h:8.11 orig_elements:264
      face:TimesNewRomanPSMT weight:none fontsize:9.0
      value:”19-APR-1990”]
[row 931: x:100.03 y:726.56 w:178.30 h:8.19]
  [column 1: x:100.03 y:726.56 w:178.30 h:8.19 orig_elements:258
      face:VCFALI+TimesNewRoman weight:bold fontsize:9.0
      value:”Primary Leadership Development:”]
[row 932: x:485.87 y:750.17 w:47.33 h:9.11]
  [column 1: x:485.87 y:750.17 w:47.33 h:9.11 orig_elements:204
      face:VCFALI+TimesNewRoman weight:bold fontsize:10.0
      value:”02/15/2013”]
[row 933: x:195.92 y:755.80 w:178.29 h:9.11]
  [column 1: x:195.92 y:755.80 w:178.29 h:9.11 orig_elements:205
      face:VCFALI+TimesNewRoman weight:bold fontsize:10.0
      value:”** PRIVACY ACT INFORMATION **”]
```

FIG. 9C illustrates a similar example of consolidated rows 940-956 for a bottom portion of the second page 120 shown in FIG. 1B. FIG. 9D illustrates a similar example of consolidated rows 960-977 for a bottom middle portion of the fifth page 150 shown in FIG. 1E. These portions of the electronic document 100 illustrate certain text features of interest for downstream processing of the consolidated text rows generated for the electronic document 100.

It is noted that the row consolidation techniques described in connection with FIGS. 6-9D is not necessary for performing successful downstream processing of the text rows generated according to the techniques described in connection with FIGS. 1-5J. However, the row consolidation techniques described in connection with FIGS. 6-9D do offer significant benefits in the form of providing a more consistent and simple presentation of text-based information items that may other span an indeterminate number of rows, and as a result require additional logic and computation in downstream processing.

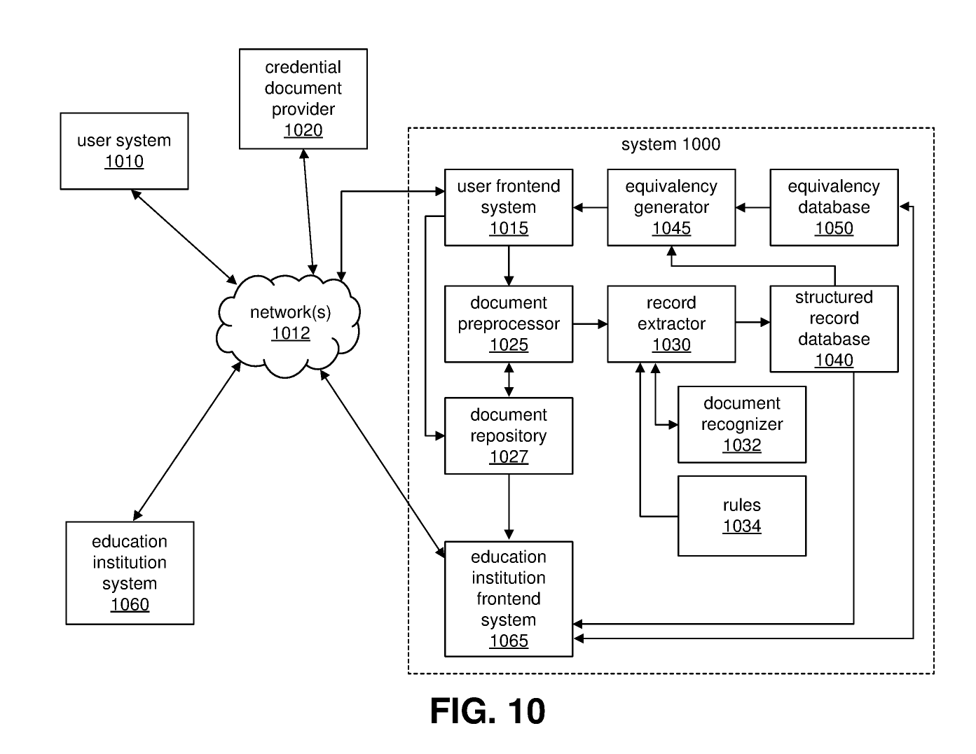

FIG. 10 illustrates an example of a system 1000 configured to employ various techniques described above in connection with FIGS. 1-9D for, among other things, automatically identifying text item structures in visual arrangements of electronic documents, extracting selected text items from the identified structures, and creating and storing structured records containing data corresponding to the selected and extracted text items. The system 1000 may employ any of the techniques described in connection with FIGS. 1-9D, including in combinations with each other. In some examples or implementations, the system 1000 may include aspects or portions described below for user system 1010, credential document provider 1020, and/or educational institution system 1060. Additionally, in some examples or implementations, aspects or portions described for system 1000 may be included in and/or performed by user system 1010, credential document provider 1020, and/or educational institution system 1060. Additionally, although FIG. 10 illustrates an example relating to collecting and processing of education-related credentials, it is understood that the described techniques may also be applied in connection with other forms of credentials encoded in electronic documents, or other non-credential information encoded in and retrieved from electronic documents.

User system 1010 is a computer system used by an end user (such as a prospective student, in the specific example illustrated in FIG. 10) used to access a user frontend system 1015 via one or more network(s) 1012. For example, an end user interface for the system 1000 may be provided and displayed to end users via a web server and/or web services implemented by user frontend system 1015 and accessed using a web browser application software program executing on the user system 1010. One or more user interfaces provided by or via the user frontend system 1015 may be arranged to enable end users to perform activities via system 1000 to register and sign on to a user account, provide and edit user information, provide electronic documents such as the example electronic document 100 illustrated in FIGS. 1A-1E to the system 1000 for processing by the system 1000, review information extracted from an electronic document (such as an electronic document uploaded by an end user), determine options and actions identified for an end user based on data extracted from such electronic documents, and/or instruct the system 1000 to perform the identified actions.

Credential document provider 1020 includes a computer system configured to provide electronic documents to end users via the network(s) 1012, which in turn end users can provide to the system 1000 via the user frontend system 1015. In some examples, the user frontend system 1015 is configured to provide information to end users (for example, in the form of instructions) for correctly obtaining particular electronic documents and allow uploading of electronic documents so obtained to the system 1000. In some implementations, the user frontend system 1015 or another element of system 1000 is configured to, in at least some circumstances, directly communicate with the credential document provider 1020 to automatically obtain one or more credential documents for an end user. Benefits of such direct communication, even to obtain the same document that an end user might otherwise be expected to obtain and provide to the system 1000, include, but are not limited to, eliminating end user actions, improving speed of interactions between end users and the system 1000, and/or ensuring that correct electronic documents are obtained from the credential document provider 1020.

The user frontend system 1015 provides electronic documents received from end users to a document preprocessor 1025 included in the system 1000. In some implementations, the user frontend system 1015 stores the electronic documents in a document repository 1027 (such as, but not limited to, a network storage device) included in the system 1000, and the document preprocessor 1025 obtains the electronic documents from the document repository 1027. In some examples, the document preprocessor 1025 is configured to store electronic documents obtained from the user frontend system 1015 in the document repository 1027. The document preprocessor 1025 is configured to apply various techniques described above in connection with FIGS. 1-9D to identify text elements and properties of the identified text elements encoded in an electronic document, and generate text rows including one or more text columns based on the identified text elements. For document formats, such as PDF, that are presentation-focused, rather than well-structured for programmatic data retrieval, this preprocessing provides a consistent, predictable, and effective identification and description of text information items that reduces complexity of, and computation performed by, downstream software. In addition to retaining copies of electronic documents obtained from users, in some implementations, the document repository 1027 may also be arranged to store and retrieve output generated by the document preprocessor 1025, such as consolidated text rows and associated text columns.

The system 1000 includes a record extractor 1030 configured to obtain text rows generated by the document preprocessor 1025 for an electronic document, identify and process structured arrangements of text information in an intended visual appearance of the electronic document based on the obtained text rows, select characters according to the structures of the arrangements of text information, and create and/or modify corresponding records stored in the structured record database 1040. Many of the activities performed by the record extractor 1030 are examples of the “downstream processing” mentioned above, although other elements of the system 1000 also perform various forms of downstream processing.

The record extractor 1030 is configured to obtain sets of rules 1034 that each select one of multiple text structure types as a function of an indicated text row. In some examples, the record extractor 1030 may include or make use of a document recognizer 1032 to determine what type of electronic document is being processed, and then select one or more sets of rules 1034 based on the determined type of electronic document. For example, the electronic document 100 illustrated in FIGS. 1A-1E may be identified as a Joint Service Transcript, and one or more sets of rules 1034 corresponding to structured arrangements of text information expected to be found, which may be specific to text layouts used in Joint Service Transcripts. In contrast, if an electronic document is identified as a transcript for an educational institution, different sets of rules 1034 may be selected than would be selected for the electronic document 100.

At least some of the rules 1034 may, in addition to, or in combination with, selecting a text information structure type for an indicated text row, additionally select characters from one or more of the text elements included in the text row to generate one or more field values for a record corresponding to the text information structure type, or perform some other function. The record may be recorded in the structured record database 1040.

Sample parameters that may be used for criteria or other aspects of applying rules 1034 to indicated text rows include, but are not limited to:
Properties of the indicated text row
   Position (x, y, page), height, width
      whether center aligned (may have configurable tolerance)
   Number of text columns
   Properties for individual selected text columns
      Font information (typeface, weight, font size)
      Position, height, width
      Characters for text column
         Regular expression matching
Properties of previous text row
   Text information structure type selected by rules
   Same text row properties as for the indicated text row
   Distance between the indicated text row and the previous text row

The record extractor 1030 may obtain a first set of rules selecting one of a plurality of row group types as a function of an indicated text row. Selection of a row group type may be implicit, such as by executing an action specified by a selecting rule. With respect to the example electronic 100 illustrated in FIGS. 1A-1E and 9A-9D, the first set of rules may include:
a first rule selecting a first group type (corresponding to text rows 703-708) according to criteria that the indicated text row has one text column, the text column is in a bold face, the text row is centered (within a configurable tolerance, such as 20 points), and the text column characters include the string “OFFICIAL” (the string matching may be case insensitive)
a second rule selecting a second group type (corresponding to text rows 709-742) according to the criteria for the first rule, but with the text column characters instead including the string “Military Course Completions”
a third rule selecting a third group type (corresponding to text rows 742 to the text row before text row 760) according to the criteria for the first rule, but with the text column characters instead including the string “Military Experience”
a fourth rule selecting a fourth group type (corresponding to text rows 760-765) according to the criteria for the first rule, but with the text column characters instead including the string “College Level Test Scores”
a fifth rule selecting a fifth group type (corresponding to text rows 766-775) according to the criteria for the first rule, but with the text column characters instead including the string “Other Learning Experiences”

The record extractor 1030 may further obtain a second set of rules each selecting a row subgroup type as a function of an indicated row. Additionally, each of the second set of rules may be associated with one or more of the plurality of row group types, and disabled unless an associated row group type has been selected using the first set of rules. With respect to the example electronic 100 illustrated in FIGS. 1A-1E and 9A-9D, the second set of rules may include:
a sixth rule associated with the second group type, selecting a first subgroup type (corresponding to, for example, text rows 913-920) according to criteria that the indicated text row has five text columns, the first text column is at a left edge of the document, and the second text column is in a bold face
a seventh rule associated with the third group type, selecting a second subgroup type (corresponding to, for example, text rows 947-951) according to criteria that the indicated text row has three text columns, the first text column is at a left edge of the document, and the second text column is in a bold face
an eighth rule associated with the fourth group type, selecting a third subgroup type (corresponding to, for example, text row 965) according to criteria that the indicated text row has five to eight text columns, each without a font weight, and the first text column is near a left edge of the document
a ninth rule associated with the fifth group type, selecting a fourth subgroup type (corresponding to, for example, text row 769) according to criteria that the indicated text row has five text columns, each of the five text columns is in bold face, and the first text column characters include the string “Course ID”
a tenth rule associated with the fifth group type, selecting a fifth subgroup type (corresponding to, for example, text rows 970-971) according to criteria that the indicated text row has five text columns, each without a font weight

In the particular example illustrated in FIG. 10, the system 1000 includes an equivalency generator 1045 configured to obtain and process credential data from the structured record database 1040 that was extracted from one or more electronic documents by the record extractor 1030. The system 1000 further includes an equivalency database 1050 arranged to store and provide requested credential equivalency information, such as in response to requests for particular credential equivalency information received from equivalency generator 1045.

FIG. 10 further illustrates an educational institution system 1060, which may interact with one or more interfaces provided by an educational institution frontend system 1065 included in the system 1000. The educational institution frontend system 1065 may provide interfaces enabling review, and confirmation or refusal, of proposed equivalent credentials for an educational institution associated with the educational institution system 1060. In some examples, the educational institution frontend system 1065 provides an interface to provide or modify credential equivalency information for the educational institution.

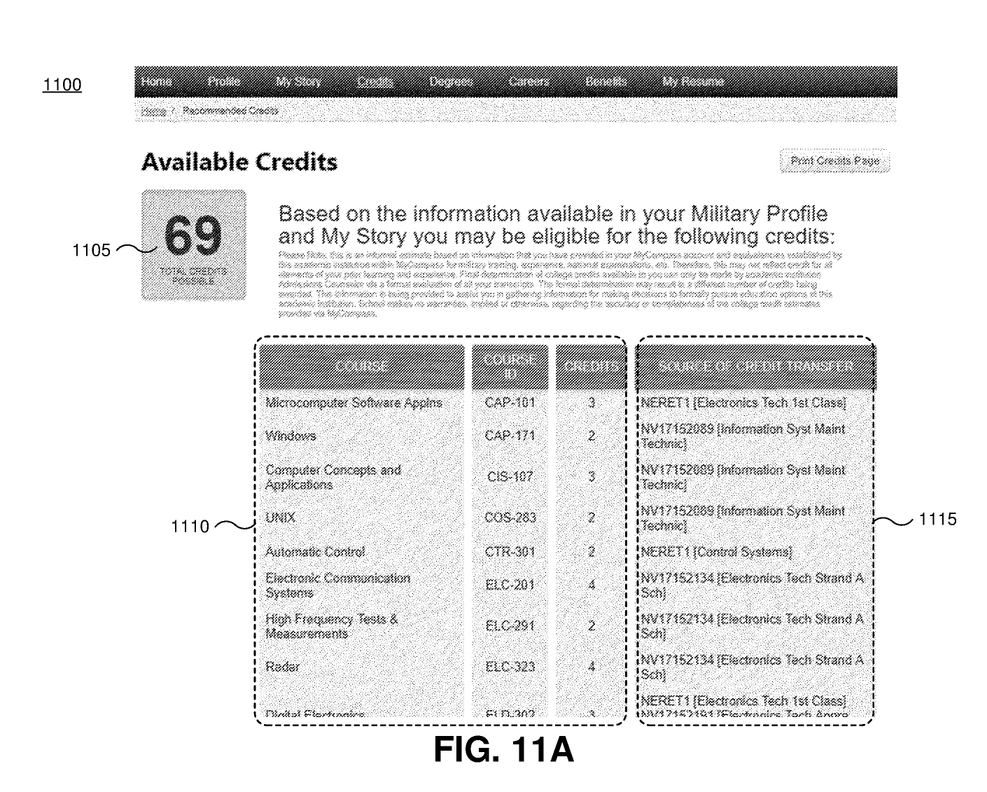

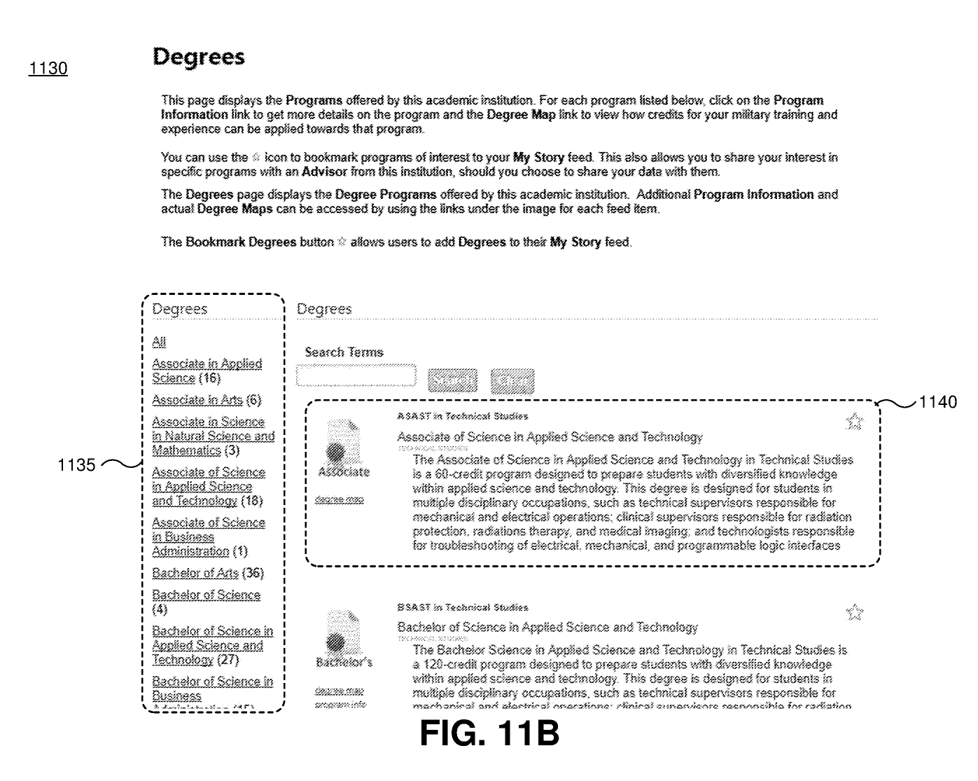

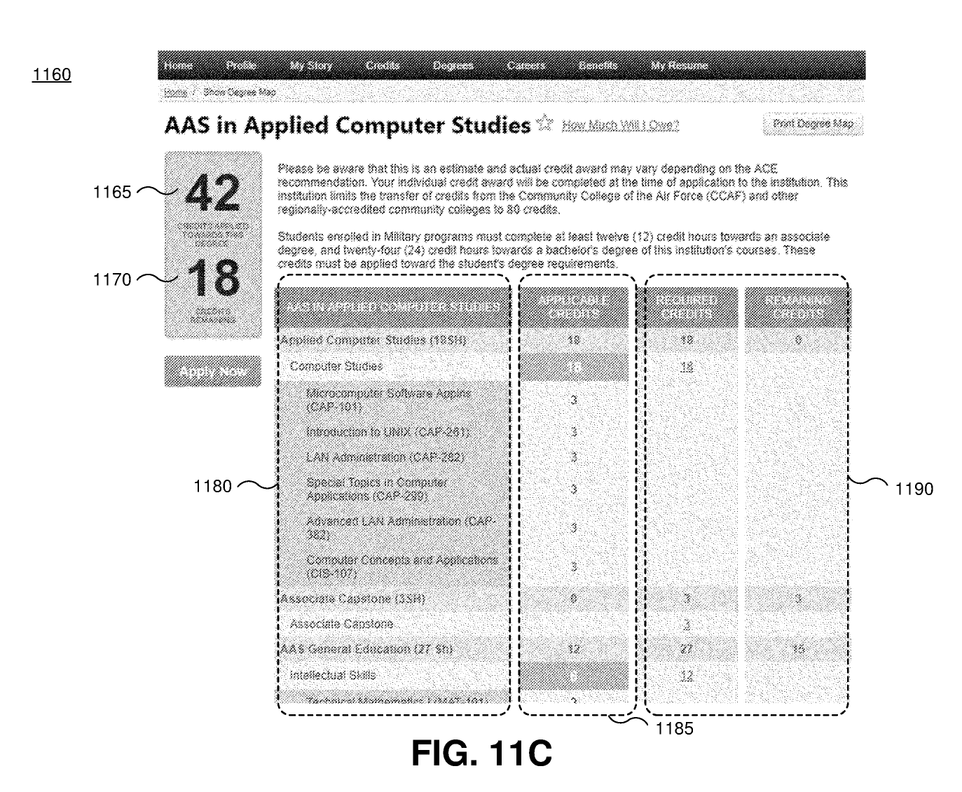

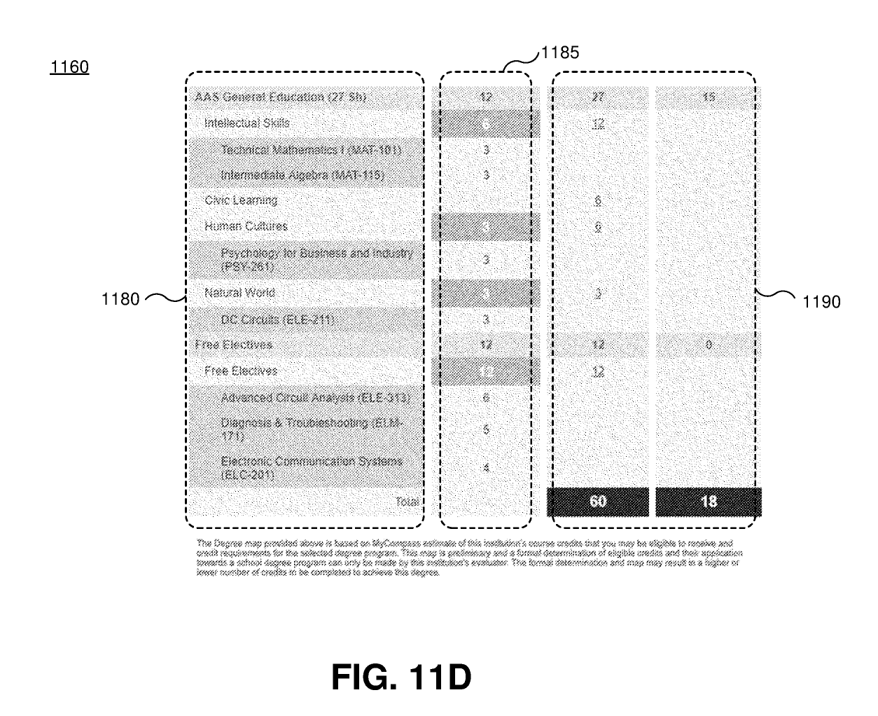

FIG. 11A illustrates an example of a first user interface 1100 displayed to an end user by the user frontend system 1015 via the user system 810 shown in FIG. 10. The first user interface 1100 displays information determined for a particular educational institution by the equivalency generator 1045 for one or more electronic documents uploaded to the system 1000 by the end user. The user interface 1100 displays, among other things, potential credits 1105, information about equivalent courses 1110 at the educational institution, and identification of the corresponding credentials 1115 identified in the uploaded electronic documents.

FIG. 11B illustrates an example of a second user interface 1130 displayed to an end user by the user frontend system 1015 via the user system 810 shown in FIG. 10. In the second user interface 1130, the information determined for the educational institution by the equivalency generator 1045 is compared against requirements for various degree programs 1135 along with indications of additional required credit hours, and detailed descriptions 1140 of the various degree programs.

FIG. 11C illustrates a first portion of an example of a third user interface 1160 displayed to an end user by the user frontend system 1015 via the user system 810 shown in FIG. 10. FIG. 11D illustrates a second portion of the example of the third user interface 1160 illustrated in FIG. 11C. In the third user interface 1160, further details are displayed for a specific degree program based on the information determined for the educational institution by the equivalency generator 1045 as compared against requirements for the displayed degree program. The third user interface 1160 displays, among other things, projected attained credit hours 1165, projected remaining credit hours 1170, degree program requirements 1180, projected applicable per-requirement credit hours 1185, and per-requirement remaining credit hours 1190.

The detailed examples of the system 1000 in FIG. 10, along with are presented herein for illustration of the disclosure and its benefits. Such examples of use should not be construed to be limitations on the logical process embodiments of the disclosure, nor should variations of user interface methods from those described herein be considered outside the scope of the present disclosure. Certain embodiments are described herein as including modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations, and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a particular processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across a number of machines. Processors or processor-implemented modules may be located in a single geographic location (for example, within a home or office environment, or a server farm), or may be distributed across multiple geographic locations.

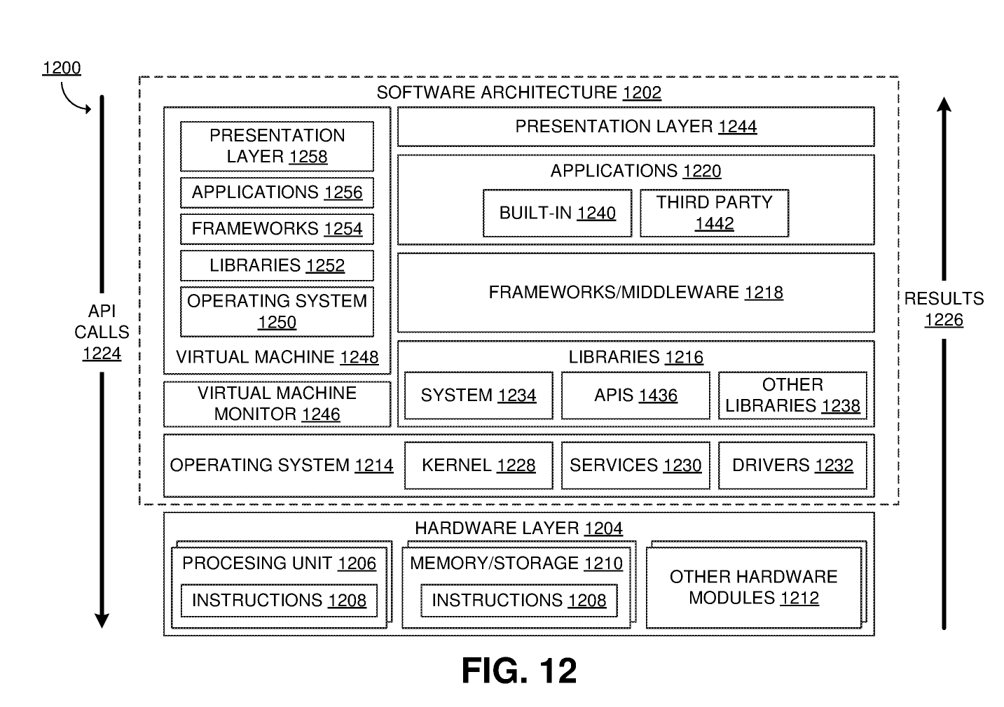

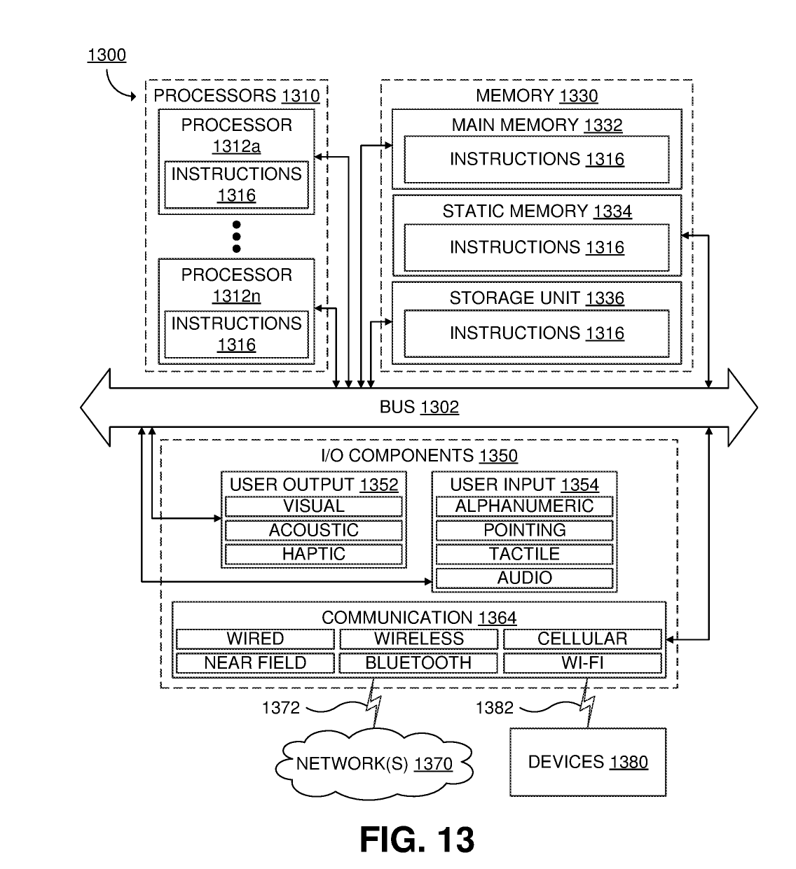

FIG. 12 is a block diagram 1200 illustrating an example software architecture 1202, various portions of which may be used in conjunction with various hardware architectures herein described, which may implement any of the above-described features. FIG. 12 is a non-limiting example of a software architecture and it will be appreciated that many other architectures may be implemented to facilitate the functionality described herein. The software architecture 1202 may execute on hardware such as a machine 1300 of FIG. 13 that includes, among other things, processors 1310, memory 1330, and input/output (I/O) components 1350. A representative hardware layer 1204 is illustrated and can represent, for example, the machine 1300 of FIG. 13. The representative hardware layer 1204 includes a processing unit 1206 and associated executable instructions 1208. The executable instructions 1208 represent executable instructions of the software architecture 1202, including implementation of the methods, modules and so forth described herein. The hardware layer 1204 also includes a memory/storage 1210, which also includes the executable instructions 1208 and accompanying data. The hardware layer 1204 may also include other hardware modules 1212. Instructions 1208 held by processing unit 1208 may be portions of instructions 1208 held by the memory/storage 1210.

The example software architecture 1202 may be conceptualized as layers, each providing various functionality. For example, the software architecture 1202 may include layers and components such as an operating system (OS) 1214, libraries 1216, frameworks 1218, applications 1220, and a presentation layer 1244. Operationally, the applications 1220 and/or other components within the layers may invoke API calls 1224 to other layers and receive corresponding results 1226. The layers illustrated are representative in nature and other software architectures may include additional or different layers. For example, some mobile or special purpose operating systems may not provide the frameworks/middleware 1218.

The OS 1214 may manage hardware resources and provide common services. The OS 1214 may include, for example, a kernel 1228, services 1230, and drivers 1232. The kernel 1228 may act as an abstraction layer between the hardware layer 1204 and other software layers. For example, the kernel 1228 may be responsible for memory management, processor management (for example, scheduling), component management, networking, security settings, and so on. The services 1230 may provide other common services for the other software layers. The drivers 1232 may be responsible for controlling or interfacing with the underlying hardware layer 1204. For instance, the drivers 1232 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1216 may provide a common infrastructure that may be used by the applications 1220 and/or other components and/or layers. The libraries 1216 typically provide functionality for use by other software modules to perform tasks, rather than rather than interacting directly with the OS 1214. The libraries 1216 may include system libraries 1234 (for example, C standard library) that may provide functions such as memory allocation, string manipulation, file operations. In addition, the libraries 1216 may include API libraries 1236 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1216 may also include a wide variety of other libraries 1238 to provide many functions for applications 1220 and other software modules.

The frameworks 1218 (also sometimes referred to as middleware) provide a higher-level common infrastructure that may be used by the applications 1220 and/or other software modules. For example, the frameworks 1218 may provide various graphic user interface (GUI) functions, high-level resource management, or high-level location services. The frameworks 1218 may provide a broad spectrum of other APIs for applications 1220 and/or other software modules.

The applications 1220 include built-in applications 1240 and/or third-party applications 1242. Examples of built-in applications 1240 may include, but are not limited to, a contacts application, a browser application, a location application, a media application, a messaging application, and/or a game application. Third-party applications 1242 may include any applications developed by an entity other than the vendor of the particular platform. The applications 1220 may use functions available via OS 1214, libraries 1216, frameworks 1218, and presentation layer 1244 to create user interfaces to interact with users.

Some software architectures use virtual machines, as illustrated by a virtual machine 1248. The virtual machine 1248 provides an execution environment where applications/modules can execute as if they were executing on a hardware machine (such as the machine 1300 of FIG. 13, for example). The virtual machine 1248 may be hosted by a host OS (for example, OS 1214) or hypervisor, and may have a virtual machine monitor 1246 which manages operation of the virtual machine 1248 and interoperation with the host operating system. A software architecture, which may be different from software architecture 1202 outside of the virtual machine, executes within the virtual machine 1248 such as an OS 1250, libraries 1252, frameworks 1254, applications 1256, and/or a presentation layer 1258.

FIG. 13 is a block diagram illustrating components of an example machine 1300 configured to read instructions from a machine-readable medium (for example, a machine-readable storage medium) and perform any of the features described herein. The example machine 1300 is in a form of a computer system, within which instructions 1316 (for example, in the form of software components) for causing the machine 1300 to perform any of the features described herein may be executed. As such, the instructions 1316 may be used to implement modules or components described herein. The instructions 1316 cause unprogrammed and/or unconfigured machine 1300 to operate as a particular machine configured to carry out the described features. The machine 1300 may be configured to operate as a standalone device or may be coupled (for example, networked) to other machines. In a networked deployment, the machine 1300 may operate in the capacity of a server machine or a client machine in a server-client network environment, or as a node in a peer-to-peer or distributed network environment. Machine 1300 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1300 is illustrated, the term “machine” include a collection of machines that individually or jointly execute the instructions 1316.

The machine 1300 may include processors 1310, memory 1330, and I/O components 1350, which may be communicatively coupled via, for example, a bus 1302. The bus 1302 may include multiple buses coupling various elements of machine 1300 via various bus technologies and protocols. In an example, the processors 1310 (including, for example, a central processing unit (CPU), a graphics processing unit (GPU), a digital signal processor (DSP), an ASIC, or a suitable combination thereof) may include one or more processors 1312a to 1312n that may execute the instructions 1316 and process data. In some examples, one or more processors 1310 may execute instructions provided or identified by one or more other processors 1310. The term “processor” includes a multi-core processor including cores that may execute instructions contemporaneously. Although FIG. 13 shows multiple processors, the machine 1300 may include a single processor with a single core, a single processor with multiple cores (for example, a multi-core processor), multiple processors each with a single core, multiple processors each with multiple cores, or any combination thereof. In some examples, the machine 1300 may include multiple processors distributed among multiple machines.

The memory/storage 1330 may include a main memory 1332, a static memory 1334, or other memory, and a storage unit 1336, both accessible to the processors 1310 such as via the bus 1302. The storage unit 1336 and memory 1332, 1334 store instructions 1316 embodying any one or more of the functions described herein. The memory/storage 1330 may also store temporary, intermediate, and/or long-term data for processors 1310. The instructions 1316 may also reside, completely or partially, within the memory 1332, 1334, within the storage unit 1336, within at least one of the processors 1310 (for example, within a command buffer or cache memory), within memory at least one of I/O components 1350, or any suitable combination thereof, during execution thereof. Accordingly, the memory 1332, 1334, the storage unit 1336, memory in processors 1310, and memory in I/O components 1350 are examples of machine-readable media.

As used herein, “machine-readable medium” refers to a device able to temporarily or permanently store instructions and data that cause machine 1300 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1316) for execution by a machine 1300 such that the instructions, when executed by one or more processors 1310 of the machine 1300, cause the machine 1300 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1350 may include a wide variety of hardware components adapted to receive input, provide output, produce output, transmit information, exchange information, capture measurements, and so on. The specific I/O components 1350 included in a particular machine will depend on the type and/or function of the machine. For example, mobile devices such as mobile phones may include a touch input device, whereas a headless server or IoT device may not include such a touch input device. The particular examples of I/O components illustrated in FIG. 13 are in no way limiting, and other types of components may be included in machine 1300. The grouping of I/O components 1350 are merely for simplifying this discussion, and the grouping is in no way limiting. In various examples, the I/O components 1350 may include user output components 1352 and user input components 1354. User output components 1352 may include, for example, display components for displaying information (for example, a liquid crystal display (LCD) or a projector), acoustic components (for example, speakers), haptic components (for example, a vibratory motor or force-feedback device), and/or other signal generators. User input components 1354 may include, for example, alphanumeric input components (for example, a keyboard or a touch screen), pointing components (for example, a mouse, a touchpad, or another pointing instrument), tactile input components (for example, a physical button or a touch screen that provides location and/or force of touches or touch gestures), and/or audio input components (for example, a microphone) configured for receiving various user inputs, such as user commands and/or selections.

The I/O components 1350 may include communication components 1364, implementing a wide variety of technologies operable to couple the machine 1300 to network(s) 1370 and/or device(s) 1380 via respective communicative couplings 1372 and 1382. The communication components 1364 may include one or more network interface components or other suitable devices to interface with the network(s) 1370. The communication components 1364 may include, for example, components adapted to provide wired communication, wireless communication, cellular communication, Near Field Communication (NFC), Bluetooth communication, Wi-Fi, and/or communication via other modalities. The device(s) 1380 may include other machines or various peripheral devices (for example, coupled via USB).

In some examples, the communication components 1364 may detect identifiers or include components adapted to detect identifiers. For example, the communication components 1364 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1362, such as, but not limited to, geo-location via Internet Protocol (IP) address, location via Wi-Fi, cellular, NFC, Bluetooth, or other wireless station identification and/or signal triangulation.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A machine-implemented method of extracting data from one or more electronic documents, the method comprising:
determining vertical positions for a plurality of text elements encoded in a first electronic document based on an intended visual appearance of the text elements encoded in the first document, wherein the text elements are encoded in the first document in an order not corresponding to the vertical positions of the text elements, and each text element has one or more characters;
generating a plurality of text rows, each text row generated for a respective subset of one or more of the text elements based on at least the vertical positions determined for the subset of the text elements;
determining a vertical position for each of the text rows based on the vertical positions determined for the subset of text elements used to generate the text row;
generating a plurality of text cells, each text cell being associated with a respective one of the plurality of text rows, and each text cell including the characters from one or more of the subset of text elements used to generate the text row associated with the text cell;
obtaining a first set of rules each selecting one of a plurality of row group types as a function of an indicated text row, wherein the plurality of row group types includes a first row group type;
obtaining a second set of rules each selecting a row subgroup type as a function of an indicated row, wherein the plurality of row subgroup types includes a first row subgroup type associated with the first row group type;
associating a first text row included in the text rows with the first row group type by applying the first set of rules to the first text row;
associating a second text row included in the text rows with the first row subgroup type by applying the second set of rules to the second text row based at least on the first text row having been associated with the first row group type and the vertical position determined for the second text row being below the vertical position determined for the first text row;
selecting one of a plurality of the generated text rows associated with a third text row included in the text rows based at least on the second text row having been associated with the first row subgroup type; and
creating a record in an electronic database, the record including a field value based on the characters included in a text cell associated with the third text row.

2. The method of claim 1, wherein each of said first set of rules and each of said second set of rules comprises a rule's criteria and a rule's function.

3. The method of claim 1, wherein the generating the plurality of text rows includes:
determining that a first text element included in the plurality of text elements has a substantial vertical overlap with a fourth text row included in the plurality of text rows;
associating the first text element with the fourth text row based on at least the determined substantial vertical overlap of the first text element with the fourth text row;
determining, at a time a fifth text row included in the plurality of text rows has not been generated, that a second text element included in the plurality of text elements does not have substantial vertical overlap with any of the plurality of text rows that have already been generated; and
generating, in response to the determination that the second text element does not have substantial vertical overlap with any of the already generated text rows, the fifth text row and associating the fifth text row with the second text element.

4. The method of claim 3, further comprising:
determining that a third text element included in the plurality of text elements has a substantial vertical overlap with the fifth text row; and
determining a horizontal position for the third text element;
wherein the generating the plurality of text cells includes:
generating, in response to the determination that the second text element does not have substantial vertical overlap with any of the already generated text rows, a first text cell included in the plurality of text cells and associating the first text cell with the fifth text row,
determining that the third text element is not positioned near the first text cell in a horizontal direction, and
generating, in response to the determination that third text element has a substantial vertical overlap with the fifth text row and the determination that the third text element is not positioned near the first text cell, a second text cell included in the plurality of text cells and associating the second text cell with the fifth text row.

5. The method of claim 1, further comprising:
determining a first text element included in the plurality of text elements has a substantial vertical overlap with a fourth text row included in the plurality of text rows;
determining a horizontal position for the first text element;
determining that a first text cell associated with the fourth text row is positioned near the first text element in a horizontal direction; and
combining, in response to the determination that first text element has a substantial vertical overlap with the fourth text row and the determination that the first text element is not positioned near the first text cell, the characters of the first text element with characters included in the first text cell into a second text cell included in the plurality of text cells.

6. The method of claim 1, wherein the generating the plurality of text cells comprises:
generating a first text cell associated with a fourth text row generated for a first subset of one or more of the text elements;
generating a second text cell associated with a fifth text row generated for a first subset of one or more of the text elements;
determining that a horizontal position of the first text cell is within a horizontal distance threshold from a horizontal position of the second text cell;
determining that the first text cell and the second text cell are arranged within a vertical distance threshold; and
consolidating, in response to the determinations that the first and second text cells are within the horizontal and vertical distance thresholds, the fourth and fifth text rows into a single sixth text row.

7. The method of claim 1, wherein the first electronic document is encoded as a Portable Document Format (PDF) file.

8. The method of claim 1, wherein a first rule included in the second set of rules includes a criteria based on at least a number of text cells associated an indicated text row and a font weight used for at least one selected text cell.

9. A machine-readable medium including instructions which, when executed by one or more processors, cause the processors to perform the method of claim 1.

10. A machine-readable medium including instructions which, when executed by one or more processors, cause the processors to perform the method of claim 4.

11. A system for extracting data from one or more electronic documents, the system comprising one or more processors and one or more machine-readable media including instructions which, when executed by the processors, cause the processors to:
determine vertical positions for a plurality of text elements encoded in a first electronic document based on an intended visual appearance of the text elements encoded in the first document, wherein the text elements are encoded in the first document in an order not corresponding to the vertical positions of the text elements, and each text element has one or more characters;
generate a plurality of text rows, each text row generated for a respective subset of one or more of the text elements based on at least the vertical positions determined for the subset of the text elements;
determine a vertical position for each of the text rows based on the vertical positions determined for the subset of text elements used to generate the text row;
generate a plurality of text cells, each text cell being associated with a respective one of the plurality of text rows, and each text cell including the characters from one or more of the subset of text elements used to generate the text row associated with the text cell;
obtain a first set of rules each selecting one of a plurality of row group types as a function of an indicated text row, wherein the plurality of row group types includes a first row group type;
obtain a second set of rules each selecting a row subgroup type as a function of an indicated row, wherein the plurality of row subgroup types includes a first row subgroup type associated with the first row group type;
associate a first text row included in the text rows with the first row group type by applying the first set of rules to the first text row;
associate a second text row included in the text rows with the first row subgroup type by applying the second set of rules to the second text row based at least on the first text row having been associated with the first row group type and the vertical position determined for the second text row being below the vertical position determined for the first text row;
select one of a plurality of the generated text rows associated with a third text row included in the text rows based at least on the second text row having been associated with the first row subgroup type; and
create a record in an electronic database, the record including a field value based on the characters included in a text cell associated with the third text row.

12. The system of claim 11, wherein each of said first set of rules and each of said second set of rules comprises a rule's criteria and a rule's function.

13. The system of claim 11, wherein the media include instructions which cause the processors to:
determine that a first text element included in the plurality of text elements has a substantial vertical overlap with a fourth text row included in the plurality of text rows;
associate the first text element with the fourth text row based on at least the determined substantial vertical overlap of the first text element with the fourth text row;
determine, at a time a fifth text row included in the plurality of text rows has not been generated, that a second text element included in the plurality of text elements does not have substantial vertical overlap with any of the plurality of text rows that have already been generated; and
generate, in response to the determination that the second text element does not have substantial vertical overlap with any of the already generated text rows, the fifth text row and associating the fifth text row with the second text element.

14. The system of claim 13, wherein the media include instructions which cause the processors to:
determine that a third text element included in the plurality of text elements has a substantial vertical overlap with the fifth text row;
determine a horizontal position for the third text element;
generate, in response to the determination that the second text element does not have substantial vertical overlap with any of the already generated text rows, a first text cell included in the plurality of text cells and associating the first text cell with the fifth text row;
determine that the third text element is not positioned near the first text cell in a horizontal direction; and
generate, in response to the determination that third text element has a substantial vertical overlap with the fifth text row and the determination that the third text element is not positioned near the first text cell, a second text cell included in the plurality of text cells and associating the second text cell with the fifth text row.

15. The system of claim 11, wherein the media include instructions which cause the processors to:
determine a first text element included in the plurality of text elements has a substantial vertical overlap with a fourth text row included in the plurality of text rows;
determine a horizontal position for the first text element;
determine that a first text cell associated with the fourth text row is positioned near the first text element in a horizontal direction; and
combine, in response to the determination that first text element has a substantial vertical overlap with the fourth text row and the determination that the first text element is not positioned near the first text cell, the characters of the first text element with characters included in the first text cell into a second text cell included in the plurality of text cells.

16. The system of claim 11, wherein the media include instructions which cause the processors to:
generate a first text cell associated with a fourth text row generated for a first subset of one or more of the text elements;
generate a second text cell associated with a fifth text row generated for a second subset of one or more of the text elements;
determine that a horizontal position of the first text cell is within a horizontal distance threshold from a horizontal position of the second text cell;
determining that the first text cell and the second text cell are arranged within a vertical distance threshold; and
consolidating, in response to the determinations that the first and second text cells are within the horizontal and vertical distance thresholds, the fourth and fifth text rows into a single sixth text row.

17. The system of claim 11, wherein the first electronic document is encoded as a Portable Document Format (PDF) file.

18. The system of claim 11, wherein a first rule included in the second set of rules includes a criteria based on at least a number of text cells associated an indicated text row and a font weight used for at least one selected text cell.
